(19) United States
(12) Patent Application Publication
(10) Pub. No.: US 2026/0171702 A1
(43) Pub. Date: Jun. 18, 2026

(54) CONDUCTIVE POLYMER CONTACTS FOR WEARABLE DEVICES

(71) Applicant: Meta Platforms Technologies, LLC, Menlo Park, CA (US)

(72) Inventors: Li Yao, Kirkland, WA (US); Phelan Miller, Duvall, WA (US); Benjamin Cook, Woodinville, WA (US); Derek William Wright, San Francisco, CA (US); Terek Li, Redmond, WA (US)

(21) Appl. No.: 19/410,996

(22) Filed: Dec. 5, 2025

Related U.S. Application Data
(60) Provisional application No. 63/734,966, filed on Dec. 17, 2024.

(51) Int. Cl. H01R 13/03; H01R 43/16

(52) U.S. Cl. CPC H01R 13/03; H01R 43/16

(57) ABSTRACT

An apparatus of the subject technology comprises an electrical interface including at least one first conductive contact and at least one second conductive contact. The first conductive contact(s) and the second conductive contact(s) are configured to include conductive polymer and are formed in an underlying nonconductive matrix.

### CROSS REFERENCE TO RELATED APPLICATIONS

The present disclosure is related and claims priority under 35 USC § 119 (e) to U.S. Provisional Application No. 63/734,966, entitled “CONDUCTIVE POLYMER CONTACTS FOR WEARABLE DEVICES,” filed on Dec. 17, 2024, the content of which is herein incorporated by reference, in its entirety, for all purposes.

### TECHNICAL FIELD

The present disclosure generally relates to electrically conductive contacts, and more particularly, to electrically conductive polymer contacts for wearable devices.

### BACKGROUND

Wearable electronic devices have become increasingly prevalent across consumer, medical, and industrial domains, offering real-time physiological monitoring, immersive user experiences, and enhanced mobility. Many of these devices such as electromyography (EMG) systems, fitness trackers, and head-mounted display (HMD) headsets rely on swappable straps or bands that incorporate metal contact interfaces to facilitate electrical connectivity and modularity. However, these metal contacts present several persistent challenges. Over time, exposure to environmental factors such as humidity, sweat, and skin oils can lead to corrosion and mechanical degradation, compromising signal integrity and device reliability. Furthermore, to maintain consistent contact pressure and alignment, these interfaces often require intricate compliance mechanisms, which add complexity to the design and increase the risk of mechanical failure.

In addition to corrosion and wear, metal contact interfaces are particularly vulnerable to water ingress, which can result in short circuits, signal attenuation, or complete device failure. This susceptibility limits the usability of wearable devices in wet or high-humidity environments, such as during intense physical activity, outdoor use, or clinical applications involving hydrotherapy. The need for robust sealing and protective coatings further complicates manufacturing and increases cost. These limitations underscore the importance of developing alternative interface technologies that offer improved durability, simplified mechanical integration, and enhanced resistance to environmental stressors. The present disclosure addresses these challenges by proposing a solution that mitigates the drawbacks of traditional metal contacts while preserving or enhancing device functionality.

### SUMMARY

According to some aspects, an apparatus of the subject technology comprises an electrical interface including at least one first conductive contact and at least one second conductive contact. The first conductive contact(s) and the second conductive contact(s) are configured to include a conductive polymer and are formed in an underlying nonconductive matrix.

According to other aspects, a wearable electronic device of the subject technology comprises an interface to transmit power or signal. The interface includes a number of first conductive contacts and several second conductive contacts. The first conductive contacts and the second conductive contacts are configured to include a conductive polymer and are formed in an underlying nonconductive matrix including a nonconductive polymer.

According to yet other aspects, a method of the subject technology includes forming an electrical interface by forming at least one first conductive contact using an over-molding process and forming at least one second conductive contact pairing the first conductive contact(s). The first conductive contact(s) and the second conductive contact(s) are formed in an underlying nonconductive matrix and are configured to include a conductive polymer.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating a conductive polymer interface, in accordance with some embodiments of the subject technology.

FIGS. 2A, 2B and 2C are schematic diagrams illustrating different views of a conductive polymer interface, in accordance with some aspects of the subject technology.

FIG. 3 is a schematic diagram illustrating an example augmented reality (AR) system using some aspects of the subject technology.

FIGS. 4A and 4B are schematic diagrams illustrating example user interactions with an AR system using some aspects of the subject technology.

FIG. 5 is a schematic diagram illustrating an example of a wrist-wearable of an AR system using some aspects of the subject technology.

FIG. 6 is a schematic diagram illustrating an example architecture of a wrist-wearable AR system using some aspects of the subject technology.

FIG. 7 is a schematic diagram illustrating an example of an AR system using some aspects of the subject technology.

FIGS. 8A and 8B are schematic diagrams illustrating different views of an example virtual reality (VR) system using some aspects of the subject technology.

FIG. 9 is a schematic diagram illustrating an example architecture of an AR and VR system using some aspects of the subject technology.

FIGS. 10A and 10B are schematic diagrams illustrating different views of an example haptic feedback device using some aspects of the subject technology.

FIG. 11 is a schematic diagram illustrating an example system architecture of a haptic feedback device using some aspects of the subject technology.

FIG. 12 is a schematic diagram illustrating an example process of over-molding conductive elastomers onto conductive pins, in accordance with some aspects of the subject technology.

FIG. 13 illustrates charts of mechanical performance of an example conductive polymer interface, in accordance with some aspects of the subject technology.

FIG. 14 is a chart illustrating electrical performance of an example conductive polymer interface, in accordance with some aspects of the subject technology.

FIG. 15 is a table illustrating values of various parameters of an example conductive polymer interface due to wear or environmental exposure, in accordance with some aspects of the subject technology.

FIG. 16 illustrates charts of signal attenuation versus frequency of an example conductive polymer interface, in accordance with some aspects of the subject technology.

FIG. 17 illustrates charts of passive-intermodulation (PIM) versus compressive force of an example multi-walled carbon nanotube (MWCNT) polymer-to-polymer interface, in accordance with some aspects of the subject technology.

FIG. 18 is a flow diagram illustrating a process of fabricating a conductive polymer interface, in accordance with some embodiments of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to a conductive polymer strap interface, which can serve as an alternative to traditional pogo-pin style conductive interfaces. The term “conductive” in the context of the present disclosure refers to electrically conductive. The disclosed conductive polymer contacts may leverage properties of conductive polymers to mitigate the issues observed with metal interfaces. Some potential benefits include, but are not limited to, corrosion resistance, waterproof and ingress protection, compliance and low modulus, and manufacturability and low cost.

For example, unlike metal, polymer composites such as silicone with a carbon nanotube (CNT) filler are inherently resistant to corrosion. Also, the polymer encapsulation of a conductive filler may improve protection against water and moisture compared to metal contacts. Further, in some example implementations, the compliance of elastomers may eliminate the need for additional springs to ensure physical contact at the interface. In terms of manufacturability and cost, the disclosed techniques such as the dual-shot injection molding not only improve manufacturing efficiency but also reduce costs.

In some embodiments of the present disclosure, conductive contacts may include, but are not limited to, silicone-based elastomer material with electrically conductive carbon-based fillers, such as carbon nanotubes or/and carbon nanofibers to provide balanced conductivity and compliance for this application. Additionally, other example elastomers can include a thermoset polymer, such as a silicone, a urethane, an acrylate, a methacrylate, a fluoropolymer, an epoxy, a thiol-ene, an unsaturated ester, a phenolic resin, and/or combinations thereof. Other elastomers can include a thermoplastic polymer, such as a styrenic block copolymer, such as a styrene-ethylene/butylene-styrene copolymer (SEBS), a styrene ethylene/proylene-styrene (SEPS) copolymer, a styrene-isoprene-styrene (SIS) block polymer, and a styrene-butadiene-styrene (SBS) block polymer.

Different elastomer matrices may affect durability and compliance of the contact interface. For example, SEBS has highest Shoreline hardness, highest toughness, similar elongation at break as silicone and poor abrasion resistance. Shore hardness is a measure of a material's resistance to indentation, which indicates its stiffness or flexibility. Urethane has moderate Shoreline hardness, moderate toughness, lowest elongation at break, and excellent abrasion resistance. Polydimethylsiloxane (PDMS, aka silicone) has lowest Shoreline hardness, lowest toughness, and excellent abrasion resistance.

The conductive filler can include a high aspect ratio conductive filler including, but not limited to, a so-called silicone one-dimensional (1-D) filler, a so-called two-dimensional (2-D) filler, and/or a combination thereof. Example conductive fillers of the present disclosure include a carbon-based filler, such as carbon nanotubes, carbon nanofibers, graphene materials, graphite, and/or a combination thereof. Additional exemplary conductive fillers can include a metal material, such as aluminum, copper, silver, gold, nickel-coated gold, and/or a combination thereof. As a further example, conductive fillers may include conductive inorganic material. One or more surfaces of the conductive filler can be functionalized with a functional group, such as a hydroxyl (—OH) group, a carboxylic (—C(O)O—) group, a thiol (—SH) group, and/or an amino (—NH2) group.

Materials such as MWCNT, SWCNT, silver nano wires and carbon black (CB) have been tested as fillers. Out of these, SWCNT offers the highest electrical conductivity and minimum degradation to elasticity of silicone resin while requiring the lowest additive content to establish percolation threshold. However, MWCNT offers excellent performance to cost trade off, and thus was investigated in-depth. In addition, secondary doped poly(3,4-ethylenedioxythiophene) polystyrene sulfonate (PEDOT:PSS) has also been studied as a filler in a crosslinked polyvinyl alcohol (PVOH, PVA) matrix, offering five times lower resistivity as to a carbon-silicone system but with much higher rigidity and less elasticity.

The optimal filler loading percentage in conductive elastomer composites is determined by the interplay between electrical and mechanical properties. Electrical conductivity increases sharply once the filler content reaches the percolation threshold—the critical concentration at which a continuous network of conductive pathways forms throughout the polymer matrix. Below this threshold, the composite remains mostly insulating; above it, conductivity rises exponentially. However, further increasing the filler loading beyond the percolation threshold yields only marginal improvements in conductivity. The percolation thresholds for single walled carbon nanotubes (SWCNT) and multi walled carbon nanotubes (MWCNT) are ˜0.1 wt % and ˜1.0 wt %.

Mechanically, increasing filler loading generally makes the material tougher, stiffer, and harder in a near-linear fashion, which can reduce flexibility and compliance. Therefore, the ideal loading is typically just above the percolation threshold, where conductivity is maximized without excessively compromising mechanical softness and stretchability. In some application scenarios, higher loading may be necessary to meet specific electrical requirements, even if it results in a stiffer material. Ultimately, the optimal percentage depends on the target balance of conductivity and flexibility for the intended use case. In addition, excessively high filler loading can lead to a crumbling composite, as the filler becomes difficult to disperse and integrate into the polymer matrix. This limitation is also influenced by processing temperature-higher temperatures decrease the viscosity of the matrix, which can enable higher filler loading before reaching the point of poor blend-ability and mechanical failure.

In some implementations, the conductive elastomers can be over-molded on metallic pins through compression molding and/or injection molding. In some embodiments, the conductive contact interface may be formed by dual-shot injection molding of the conductive and non-conductive elastomers to form the detachable interface/interconnect. Compared to existing solutions, the shift from metal to polymer and manufacturing processes such as dual-shot injection molding may facilitate efficient manufacturing and may result in a durable interface capable of exposure to sweat and other environmental conditions. The minimum achievable feature size for contact pins is about 0.5 mm in diameter, while the maximum tested value is about 2.0 mm. Increasing the pin diameter beyond this range would require a correspondingly larger strap interface. Thus, the practical scalability limits are set by the need to balance miniaturization with mechanical robustness and the overall size constraints of the wearable device.

In the disclosed application, the key process parameters for dual-shot injection molding include the applied pressure for conductive and non-conductive material, the design of both molds to ensure precise alignment, the use of surface treatments such as oxygen plasma or self-assembled-monolayer release/adhere coating, molding temperature to control degree of crosslinking, and cooling temperature/time. These parameters may be modified to promote strong adhesion, precise alignment, and high yield.

The interfaces of the subject technology may be implemented by bump-style or flat contacts. Bump-style contacts may improve effective contact area and reduce resistance at lower pressure but require precise molding and alignment. Flat contacts are easier to manufacture but may have higher resistance and less compliance. Precise alignment of conductive and non-conductive regions during molding is essential to maintain consistent contact geometry and prevent electrical shorting. This process can be challenging due to the need for exact placement and separation of materials within the mold. To address this, a dowel pin is used to ensure precise alignment of the mold components, helping maintain the integrity of the interface and reducing the risk of misalignment-related defects.

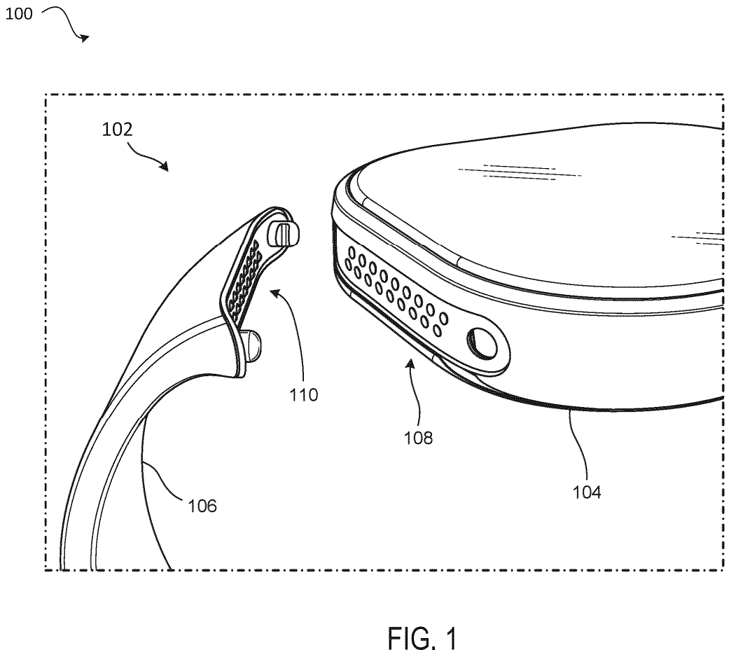

Turning now to the figures, FIG. 1 is a schematic diagram illustrating a conductive polymer interface, in accordance with some embodiments of the subject technology. As shown in FIG. 1, a wearable device 100 may include a conductive polymer interface 102, such as for electrically connecting a wearable body 104 with a wearable strap 106, such as for transmitting power, data signals, etc. The conductive polymer interface 102 may include first conductive contacts 108 on the wearable body 104 and second conductive contacts 110 on the wearable strap 106. The first conductive contacts 108 and the second conductive contacts 110 may be arranged to be complementary to each other to respectively match up to form electrical connections. In some embodiments, the first conductive contacts 108 may be or include conductive polymer contacts, as described herein. In some embodiments, the second conductive contacts 110 may be or include conductive polymer contacts, as described herein. Opposing conductive contacts may be formed of a conductive polymer (e.g., a polymer matrix with a conductive filler) or of another conductive material (e.g., metal). In some embodiments, both the first conductive contacts 108 and the second conductive contacts 110 may be or include conductive polymer contacts, as described herein.

In some examples, at least some of the conductive polymer contacts may be formed as bumps that protrude from an underlying matrix. These conductive polymer contacts may be formed of an elastomer material with a conductive filler. Accordingly, the elastomer material of the conductive polymer contacts may deform as they are pressed against the other conductive contacts at the interface, such as when the wearable body 104 is coupled to the wearable strap 106. For example, as illustrated in FIG. 1, the second conductive contacts 110 of the wearable strap 106 are formed as bumps. The opposing conductive contacts, such as the first conductive contacts 108 of the wearable body 104, may be formed as substantially flat contacts (e.g., as shown in FIG. 1) or as bumps.

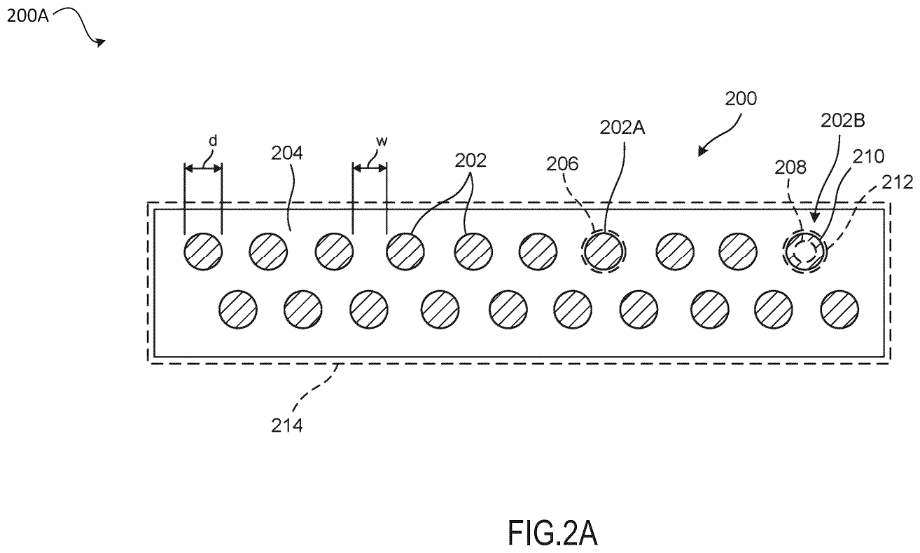

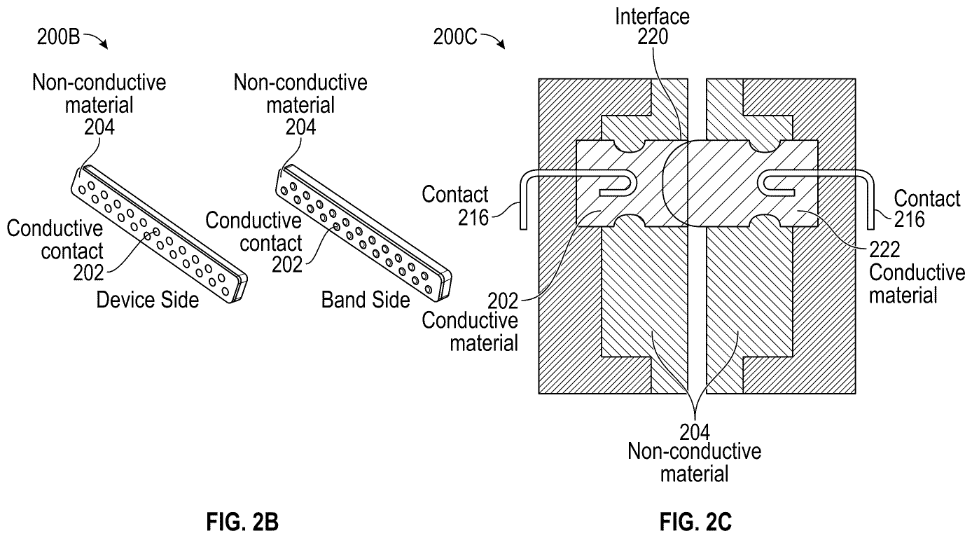

FIGS. 2A, 2B and 2C are schematic diagrams illustrating different views of a conductive polymer interface, in accordance with some aspects of the subject technology. As shown in FIG. 2A, a conductive polymer interface 200A for a wearable device (e.g., an EMG strap, etc.) can include distinct conductive contacts 202 formed of a conductive elastomer (e.g., an elastomer with a conductive filler) and a surrounding non-conductive material 204 (e.g., a polymer material, an elastomer material, etc.) as a substrate or matrix. By way of example and not limitation, a diameter d of each of the conductive contacts 202 can be between about 0.5 mm and about 2.0 mm, such as 0.5 mm, 1.0 mm, 1.5 mm, or 2.0 mm. A distance w between adjacent conductive contacts 202 can be between about 0.5 mm and about 2.0 mm, such as 0.5 mm, 1.0 mm, 1.5 mm, or 2.0 mm, for example. In additional examples (e.g., for larger interfaces), the conductive contacts 202 and/or the distance between adjacent conductive contacts 202 can be formed to have a different size (e.g., larger). In some embodiments, the conductive polymer interface 200 may be arranged as two lines of the conductive contacts 202 as shown in FIG. 2A or as shown in FIG. 1. Other arrangements of the conductive contacts 202 in the non-conductive material 204 are also contemplated and included in the present disclosure.

Optionally, in some examples, each conductive contact 202A may be surrounded (e.g., on lateral sides thereof) by a non-conductive shell 206. Optionally, in additional examples, each conductive contact 202B may be formed as a coaxial conductive contact pair, with a central conductive material 208 (e.g., a central conductive polymer material), an insulating material 210 surrounding (e.g., on lateral sides thereof) the central conductive material 208, and an outer conductive material 212 (e.g., an outer conductive polymer material). In some examples, an optional conductive shield 214 (e.g., a radio frequency (RF) shield) may surround the non-conductive material 204 and group of conductive contacts 202.

FIG. 2B is a perspective view 200B including the band side and the device side of the conductive polymer interface 200A of FIG. 2A showing the conductive contacts 202 and the non-conductive material 204.

FIG. 2C is a cross-sectional view 200C of a conductive polymer interface 220 including conductive (e.g., metal) contacts 216 embedded in the conductive material 222 and non-conductive material 204.

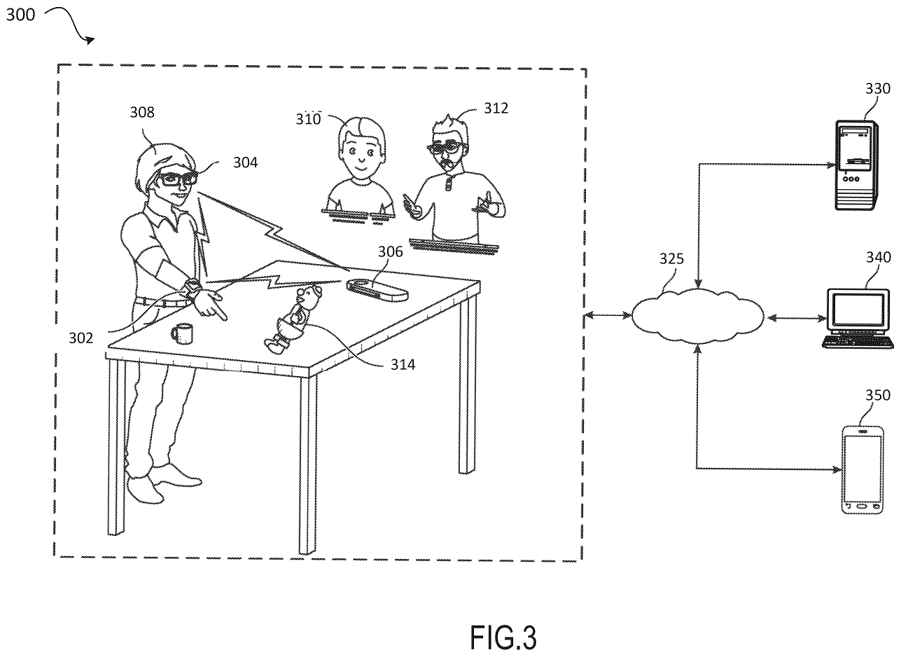

FIG. 3 is a schematic diagram illustrating an example augmented reality (AR) system 300 using some aspects of the subject technology. In the AR system 300, a wrist-wearable device 302, an AR glasses 304, and/or a handheld intermediary processing device (HIPD) 306 can communicatively couple via a network 325 (e.g., cellular, near field, Wi-Fi, personal area network, wireless LAN, etc.). Additionally, wrist-wearable device 302, AR glasses 304, and/or HIPD 306 can also communicatively couple with one or more servers 330, computers 340 (e.g., laptops, computers, etc.), mobile devices 350 (e.g., smartphones, tablets, etc.), and/or other electronic devices via network 325 (e.g., cellular, near field, Wi-Fi, personal area network, wireless LAN, etc.).

In FIG. 3, a user 308 is shown wearing wrist-wearable device 302 and AR glasses 304 and having HIPD 306 on their desk. The wrist-wearable device 302, AR glasses 304, and HIPD 306 facilitate user interaction with an AR environment. In particular, as shown by first AR system 300, wrist-wearable device 302, AR glasses 304, and/or HIPD 306 cause presentation of one or more avatars 310, digital representations of contacts 312, and virtual objects 314. As discussed below, user 308 can interact with one or more avatars 310, digital representations of contacts 312, and virtual objects 314 via wrist-wearable device 302, AR glasses 304, and/or HIPD 306.

User 308 can use any of wrist-wearable device 302, AR glasses 304, and/or HIPD 306 to provide user inputs. For example, user 308 can perform one or more hand gestures that are detected by wrist-wearable device 302 (e.g., using one or more EMG sensors and/or IMUs) and/or AR glasses 304 (e.g., using one or more image sensors or a camera to provide a user input). Alternatively, or additionally, user 308 can provide a user input via one or more touch surfaces of wrist-wearable device 302, AR glasses 304, HIPD 306, and/or voice commands captured by a microphone of wrist-wearable device 302, AR glasses 304, and/or HIPD 306. In some embodiments, wrist-wearable device 302, AR glasses 304, and/or HIPD 306 include a digital assistant to help user 308 in providing a user input (e.g., completing a sequence of operations, suggesting different operations or commands, providing reminders, confirming a command, etc.). In some embodiments, user 308 can provide a user input via one or more facial gestures and/or facial expressions. For example, cameras of wrist-wearable device 302, AR glasses 304, and/or HIPD 306 can track eyes of user 308 for navigating a user interface.

Wrist-wearable device 302, AR glasses 304, and/or HIPD 306 can operate alone or in conjunction to allow user 308 to interact with the AR environment. In some embodiments, HIPD 306 is configured to operate as a central hub or control center for the wrist-wearable device 302, AR glasses 304, and/or another communicatively coupled device. For example, user 308 can provide an input to interact with the AR environment at any of wrist-wearable device 302, AR glasses 304, and/or HIPD 306, and HIPD 306 can identify one or more back-end and front-end tasks to cause the performance of the requested interaction and distribute instructions to cause the performance of the one or more back-end and front-end tasks at wrist-wearable device 302, AR glasses 304, and/or HIPD 306. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.). HIPD 306 can perform the back-end tasks and provide wrist-wearable device 302 and/or AR glasses 304 operational data corresponding to the performed back-end tasks such that wrist-wearable device 302 and/or AR glasses 304 can perform the front-end tasks. In this way, HIPD 306, which has more computational resources and greater thermal headroom than wrist-wearable device 302 and/or AR glasses 304, performs computationally intensive tasks and reduces the computer resource utilization and/or power usage of wrist-wearable device 302 and/or AR glasses 304.

In the example shown by first AR system 300, HIPD 306 identifies one or more back-end tasks and front-end tasks associated with a user request to initiate an AR video all with one or more other users (represented by avatar 310 and the digital representation of contact 312) and distributes instructions to cause the performance of the one or more back-end tasks and front-end tasks. In particular, HIPD 306 performs back-end tasks for processing and/or rendering image data (and other data) associated with the AR video call and provides operational data associated with the performed back-end tasks to AR glasses 304 such that the AR glasses 304 perform front-end tasks for presenting the AR video call (e.g., presenting avatar 310 and digital representation of contact 312).

In some embodiments, HIPD 306 can operate as a focal or anchor point for causing the presentation of information. This allows user 308 to be generally aware of where information is presented. For example, as shown in first AR system 300, avatar 310 and the digital representation of contact 312 are presented above HIPD 306. In particular, HIPD 306 and AR glasses 304 operate in conjunction to determine a location for presenting avatar 310 and the digital representation of contact 312. In some embodiments, information can be presented a predetermined distance from HIPD 306 (e.g., within 5 meters). For example, as shown in first AR system 300, virtual object 314 is presented on the desk some distance from HIPD 306. Similar to the above example, HIPD 306 and AR glasses 304 can operate in conjunction to determine a location for presenting virtual object 314. Alternatively, in some embodiments, presentation of information is not bound by HIPD 306. More specifically, avatar 310, digital representation of contact 312, and virtual object 314 do not have to be presented within a predetermined distance of HIPD 306.

User inputs provided at wrist-wearable device 302, AR glasses 304, and/or HIPD 306 are coordinated such that the user can use any device to initiate, continue, and/or complete an operation. For example, user 308 can provide a user input to AR glasses 304 to cause AR glasses 304 to present virtual object 314 and, while virtual object 314 is presented by AR glasses 304, user 308 can provide one or more hand gestures via wrist-wearable device 302 to interact and/or manipulate virtual object 314.

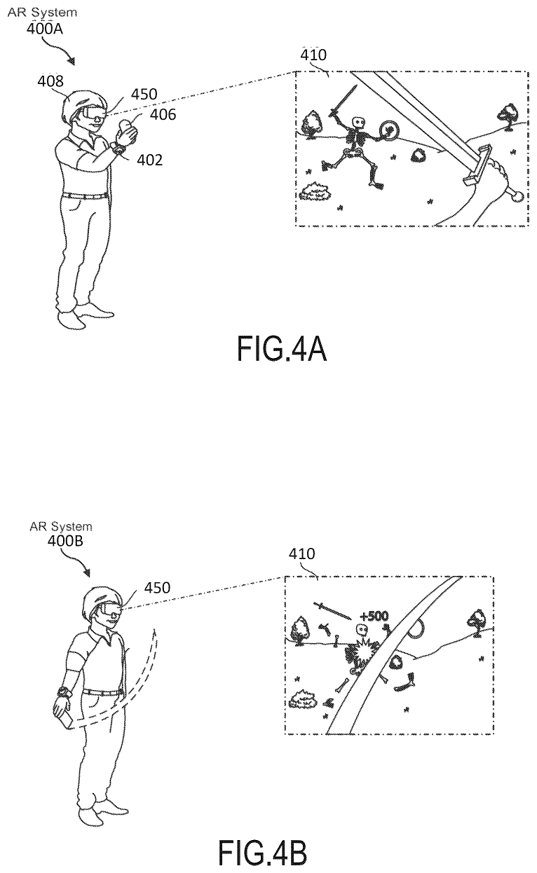

FIGS. 4A and 4B are schematic diagrams illustrating example user interactions with AR systems 400A and 400B using some aspects of the subject technology. As shown in FIGS. 4A and 4B, a user 408 may interact with the AR system 400A and 400B by donning a VR headset 450 while holding HIPD 406 and wearing wrist-wearable device 402. In this example, AR system 400A or 400B may enable users to interact with a game 410 by swiping their arm. One or more of VR headset 450, HIPD 406, and wrist-wearable device 402 may detect this gesture and, in response, may display a sword strike in game 410.

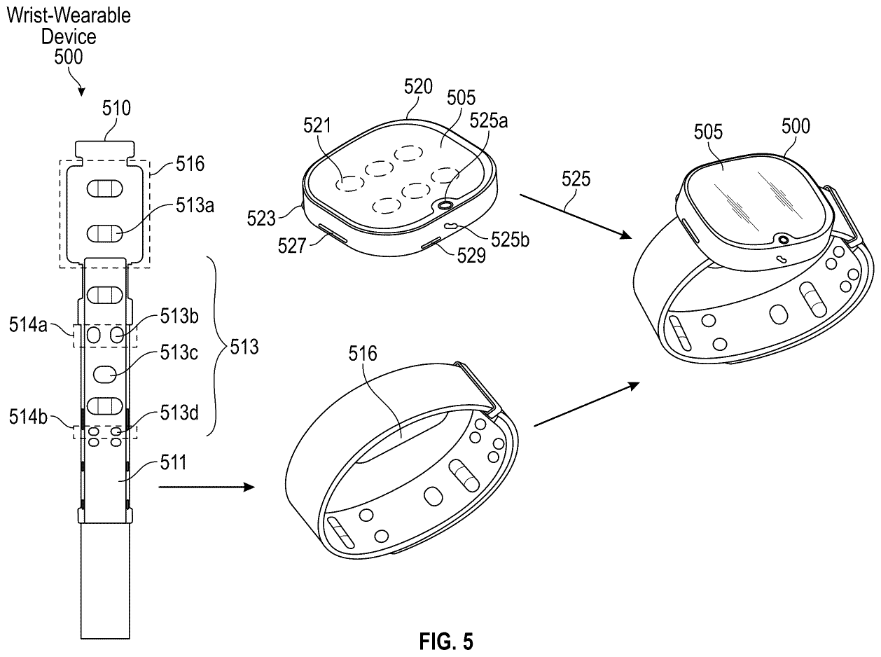

FIG. 5 is a schematic diagram illustrating an example of a wrist-wearable of an AR system using some aspects of the subject technology. FIG. 5 shows a wearable band 510 and a watch body 520 (or capsule) being coupled, as discussed below, to form wrist-wearable device 500. Wrist-wearable device 500 can perform various functions and/or operations associated with navigating through user interfaces and selectively opening applications as well as the functions and/or operations.

Example operations executed by wrist-wearable device 500 can include (i) presenting content to a user (e.g., displaying visual content via a display 505), (ii) detecting (e.g., sensing) user input (e.g., sensing a touch on peripheral button 523 and/or at a touch screen of the display 505, a hand gesture detected by sensors (e.g., biopotential sensors)), and (iii) sensing biometric data (e.g., neuromuscular signals, heart rate, temperature, sleep, etc.) via one or more sensors 513, messaging (e.g., text, speech, video, etc.), image capture via one or more imaging devices or cameras 525, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 520, independently in wearable band 510, and/or via an electronic communication between watch body 520 and wearable band 510. In some embodiments, functions can be executed on wrist-wearable device 500 while an AR environment is being presented (e.g., via one of AR systems 100 to 400). The wearable devices described herein can also be used with other types of AR environments.

Wearable band 510 can be configured to be worn by a user such that an inner surface of a wearable structure 511 of wearable band 510 is in contact with the user's skin. In this example, when worn by a user, sensors 513 may contact the user's skin. In some examples, one or more sensors 513 can sense biometric data such as a user's heart rate, a saturated oxygen level, temperature, sweat level, neuromuscular signals, or a combination thereof. One or more sensors 513 can also sense data about a user's environment, including a user's motion, altitude, location, orientation, gait, acceleration, position, or a combination thereof. In some embodiments, one or more of sensors 513 can be configured to track a position and/or motion of wearable band 510. One or more sensors 513 can include any of the sensors defined above and/or discussed below with respect to FIG. 5.

One or more sensors 513 can be distributed on an inside and/or an outside surface of wearable band 510. In some embodiments, one or more sensors 513 are uniformly spaced along wearable band 510. Alternatively, in some embodiments, one or more of sensors 513 are positioned at distinct points along wearable band 510. As shown in FIG. 5, one or more sensors 513 can be the same or distinct. For example, in some embodiments, one or more of sensors 513 can be shaped as a pill (e.g., sensor 513a), an oval, a circle, a square, an oblong (e.g., sensor 513c) and/or any other shape that maintains contact with the user's skin (e.g., such that neuromuscular signals and/or other biometric data can be accurately measured at the user's skin). In some embodiments, one or more sensors of 513 are aligned to form pairs of sensors (e.g., for sensing neuromuscular signals based on differential sensing within each respective sensor). For example, sensor 513b may be aligned with an adjacent sensor to form sensor pair 514a and sensor 513d may be aligned with an adjacent sensor to form sensor pair 514b. In some embodiments, wearable band 510 does not have a sensor pair. Alternatively, in some embodiments, wearable band 510 has a predetermined number of sensor pairs (one pair of sensors, three pairs of sensors, four pairs of sensors, six pairs of sensors, sixteen pairs of sensors, etc.).

Wearable band 510 can include any suitable number of sensors 513. In some embodiments, the number and arrangement of sensors 513 depends on the particular application for which wearable band 510 is used. For instance, wearable band 510 can be configured as an armband, wristband, or chest-band that include a plurality of sensors 513 with a different number of sensors 513, a variety of types of individual sensors with the plurality of sensors 513, and different arrangements for each use case, such as medical use cases as compared to gaming or general day-to-day use cases.

In accordance with some embodiments, wearable band 510 further includes an electrical ground electrode and a shielding electrode. The electrical ground and shielding electrodes, like the sensors 513, can be distributed on the inside surface of the wearable band 510 such that they contact a portion of the user's skin. For example, the electrical ground and shielding electrodes can be at an inside surface of a coupling mechanism 516 or an inside surface of a wearable structure 511. The electrical ground and shielding electrodes can be formed and/or use the same components as sensors 513. In some embodiments, wearable band 510 includes more than one electrical ground electrode and more than one shielding electrode.

Wearable structure 511 can be formed of an elastic material, elastomers, etc., configured to be stretched and fitted to be worn by the user. In some embodiments, wearable structure 511 is a textile or woven fabric. As described above, sensors 513 can be formed as part of a wearable structure 511. For example, sensors 513 can be molded into the wearable structure 511, or be integrated into a woven fabric (e.g., sensors 513 can be sewn into the fabric and mimic the pliability of fabric and/or can be constructed from a series of woven-strands of fabric).

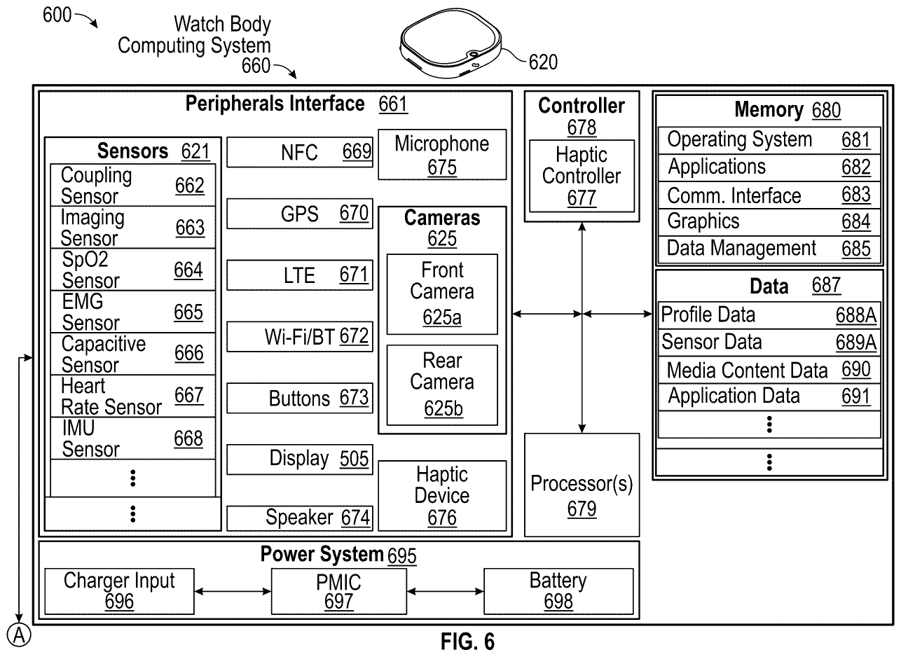

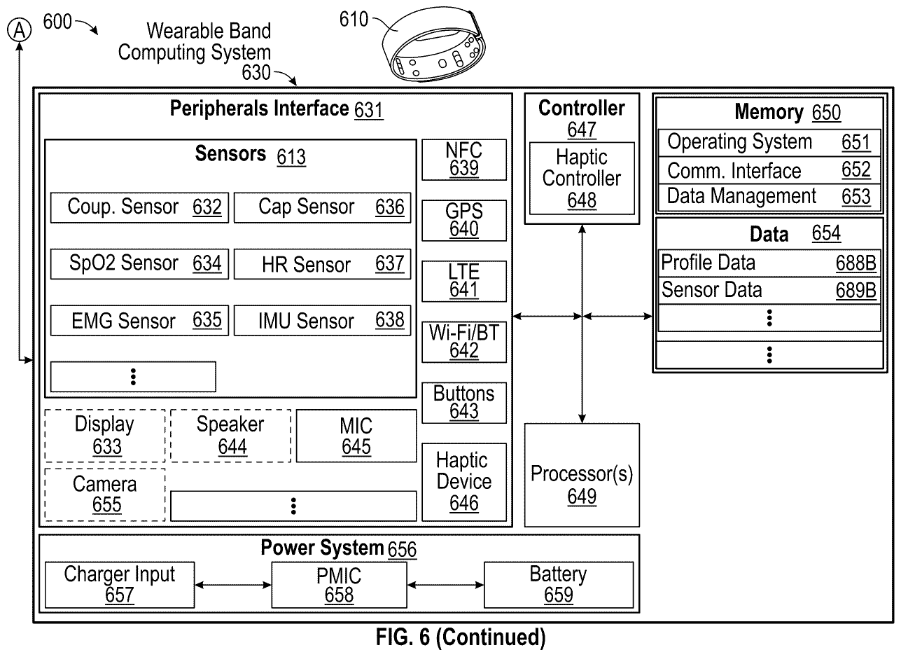

Wearable structure 511 can include flexible electronic connectors that interconnect sensors 513, the electronic circuitry, and/or other electronic components (described below in reference to FIG. 6) that are enclosed in wearable band 510. In some embodiments, the flexible electronic connectors are configured to interconnect sensors 513, the electronic circuitry, and/or other electronic components of wearable band 510 with respective sensors and/or other electronic components of another electronic device (e.g., watch body 520). The flexible electronic connectors are configured to move with wearable structure 511 such that the user adjustment to wearable structure 511 (e.g., resizing, pulling, folding, etc.) does not stress or strain the electrical coupling of components of wearable band 510.

The sensed data (e.g., sensed neuromuscular signals) can be used to detect and/or determine the user's intention to perform certain motor actions. In some examples, sensors 513 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 505 of wrist-wearable device 500 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 513 can be used to provide a user with an enhanced interaction with a physical object (e.g., devices communicatively coupled with wearable band 510) and/or a virtual object in an artificial-reality application generated by an artificial-reality system (e.g., user interface objects presented on the display 505, or another computing device (e.g., a smartphone)).

In some embodiments, wearable band 510 includes one or more haptic devices 646 (e.g., a vibratory haptic actuator) that are configured to provide haptic feedback (e.g., a cutaneous and/or kinesthetic sensation, etc.) to the user's skin. Sensors 513 and/or haptic devices 646 (shown in FIG. 6) can be configured to operate in conjunction with multiple applications including, without limitation, health monitoring, social media, games, and artificial reality (e.g., the applications associated with artificial reality).

Wearable band 510 can also include coupling mechanism 516 for detachably coupling a capsule (e.g., a computing unit) or watch body 520 (via a coupling surface of the watch body 520) to wearable band 510. For example, a cradle or a shape of coupling mechanism 516 can correspond to a shape of watch body 520 of wrist-wearable device 500. In particular, the coupling mechanism 516 can be configured to receive a coupling surface proximate to the bottom side of watch body 520 (e.g., a side opposite to a front side of watch body 520 where display 505 is located), such that a user can push watch body 520 downward into coupling mechanism 516 to attach watch body 520 to coupling mechanism 516. In some embodiments, coupling mechanism 516 can be configured to receive a top side of the watch body 520 (e.g., a side proximate to the front side of watch body 520 where display 505 is located) that is pushed upward into the cradle, as opposed to being pushed downward into coupling mechanism 516. In some embodiments, coupling mechanism 516 is an integrated component of wearable band 510 such that wearable band 510 and coupling mechanism 516 are a single unitary structure. In some embodiments, coupling mechanism 516 is a type of frame or shell that allows watch body 520's coupling surface to be retained within or on wearable band 510 and coupling mechanism 516 (e.g., a cradle, a tracker band, a support base, a clasp, etc.).

Coupling mechanism 516 can allow for watch body 520 to be detachably coupled to the wearable band 510 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 520 to wearable band 510 and to decouple the watch body 520 from the wearable band 510. For example, a user can twist, slide, turn, push, pull, or rotate watch body 520 relative to wearable band 510, or a combination thereof, to attach watch body 520 to wearable band 510 and to detach watch body 520 from wearable band 510. Alternatively, as discussed below, in some embodiments, the watch body 520 can be decoupled from the wearable band 510 by actuation of a release mechanism 529.

A user can actuate release mechanism 529 by pushing, turning, lifting, depressing, shifting, or performing other actions on release mechanism 529. Actuation of release mechanism 529 can release (e.g., decouple) watch body 520 from coupling mechanism 516 of wearable band 510, allowing the user to use watch body 520 independently from wearable band 510 and vice versa. For example, decoupling watch body 520 from wearable band 510 can allow a user to capture images using rear-facing camera 525b. Although release mechanism 529 is shown positioned at a corner of watch body 520, release mechanism 529 can be positioned anywhere on watch body 520 that is convenient for the user to actuate. In addition, in some embodiments, wearable band 510 can also include a respective release mechanism for decoupling watch body 520 from coupling mechanism 516. In some embodiments, release mechanism 529 is optional and watch body 520 can be decoupled from coupling mechanism 516 as described above (e.g., via twisting, rotating, etc.).

Watch body 520 can include one or more peripheral buttons 523 and 527 for performing various operations at watch body 520. For example, peripheral buttons 523 and 527 can be used to turn on or wake (e.g., transition from a sleep state to an active state) display 505, unlock watch body 520, increase or decrease a volume, increase or decrease a brightness, interact with one or more applications, interact with one or more user interfaces, etc. Additionally or alternatively, in some embodiments, display 505 operates as a touch screen and allows the user to provide one or more inputs for interacting with watch body 520.

In some embodiments, watch body 520 includes one or more sensors 521. Sensors 521 of watch body 520 can be the same as or distinct from sensors 513 of wearable band 510. Sensors 521 of watch body 520 can be distributed on an inside and/or an outside surface of watch body 520. In some embodiments, sensors 521 are configured to contact a user's skin when watch body 520 is worn by the user. For example, sensors 521 can be placed on the bottom side of watch body 520 and coupling mechanism 516 can be a cradle with an opening that allows the bottom side of watch body 520 to directly contact the user's skin. Alternatively, in some embodiments, watch body 520 does not include sensors that are configured to contact the user's skin (e.g., including sensors internal and/or external to the watch body 520 that are configured to sense data of watch body 520 and the surrounding environment). In some embodiments, sensors 521 are configured to track a position and/or motion of watch body 520.

Watch body 520 and wearable band 510 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 520 and wearable band 510 can share data sensed by sensors 513 and 521, as well as application and device specific information (e.g., active and/or available applications, output devices (e.g., displays, speakers, etc.), input devices (e.g., touch screens, microphones, imaging sensors, etc.)).

In some embodiments, watch body 520 can include, without limitation, a front-facing camera 525a and/or a rear-facing camera 525b, and sensors 521 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 663), a touch sensor, a sweat sensor, etc.). In some embodiments, watch body 520 can include one or more haptic devices 676 (e.g., a vibratory haptic actuator) that is configured to provide haptic feedback (e.g., a cutaneous and/or kinesthetic sensation, etc.) to the user. Sensors 621 and/or haptic device 676 can also be configured to operate in conjunction with multiple applications including, without limitation, health monitoring applications, social media applications, game applications, and artificial reality applications (e.g., the applications associated with artificial reality).

As described above, watch body 520 and wearable band 510, when coupled, can form wrist-wearable device 500. When coupled, watch body 520 and wearable band 510 may operate as a single device to execute functions (operations, detections, communications, etc.) described herein. In some embodiments, each device may be provided with particular instructions for preforming the one or more operations of wrist-wearable device 500. For example, in accordance with a determination that watch body 520 does not include neuromuscular signal sensors, wearable band 510 can include alternative instructions for performing associated instructions (e.g., providing sensed neuromuscular signal data to watch body 520 via a different electronic device). Operations of wrist-wearable device 500 can be performed by watch body 520 alone or in conjunction with wearable band 510 (e.g., via respective processors and/or hardware components) and vice versa. In some embodiments, operations of wrist-wearable device 500, watch body 520, and/or wearable band 510 can be performed in conjunction with one or more processors and/or hardware components. As described below with reference to the block diagram of FIG. 6, wearable band 510 and/or watch body 520 can each include independent resources required to independently execute functions. For example, wearable band 510 and/or watch body 520 can each include a power source (e.g., a battery), a memory, data storage, a processor (e.g., a central processing unit (CPU)), communications, a light source, and/or input/output devices.

FIG. 6 is a schematic diagram illustrating an example architecture of a wrist-wearable AR system using some aspects of the subject technology. FIG. 6 shows block diagrams of a computing system 630 corresponding to wearable band 610 and a computing system 660 corresponding to watch body 620 according to some embodiments. Computing system 600 of wrist-wearable device 500 may include a combination of components of wearable band computing system 630 and watch body computing system 660, in accordance with some embodiments.

Watch body 620 and/or wearable band 610 can include one or more components shown in watch body computing system 660. In some embodiments, a single integrated circuit may include all or a substantial portion of the components of watch body computing system 660 included in a single integrated circuit. Alternatively, in some embodiments, components of the watch body computing system 660 may be included in a plurality of integrated circuits that are communicatively coupled. In some embodiments, watch body computing system 660 may be configured to couple (e.g., via a wired or wireless connection) with wearable band computing system 630, which may allow the computing systems to share components, distribute tasks, and/or perform other operations described herein (individually or as a single device).

Watch body computing system 660 can include one or more processors 679, a controller 677, a peripherals interface 661, a power system 695, and a memory (e.g., memory 680). Power system 695 can include a charger input 696, a power-management integrated circuit (PMIC) 697, and a battery 698. In some embodiments, a watch body 620 and a wearable band 610 can have respective batteries (e.g., battery 698 and 659) and can share power with each other. Watch body 620 and wearable band 610 can receive a charge using a variety of techniques. In some embodiments, watch body 620 and wearable band 610 can use a wired charging assembly (e.g., power cords) to receive the charge. Alternatively, or in addition, watch body 620 and/or wearable band 610 can be configured for wireless charging. For example, a portable charging device can be designed to mate with a portion of watch body 620 and/or wearable band 610 and wirelessly deliver usable power to battery 698 of watch body 620 and/or battery 659 of wearable band 610. Watch body 620 and wearable band 610 can have independent power systems (e.g., power system 695 and 656, respectively) to enable each to operate independently. Watch body 620 and wearable band 610 can also share power (e.g., one can charge the other) via respective PMICs (e.g., PMICs 697 and 658) and charger inputs (e.g., 657 and 696) that can share power over power and ground conductors and/or over wireless charging antennas.

In some embodiments, peripherals interface 661 can include one or more sensors 621. Sensors 621 can include one or more coupling sensors 662 for detecting when watch body 620 is coupled with another electronic device (e.g., a wearable band 510). Sensors 621 can include one or more imaging sensors 663 (e.g., one or more of cameras 625, and/or separate imaging sensors 663 (e.g., thermal-imaging sensors)). In some embodiments, sensors 621 can include one or more SpO2 sensors 664. In some embodiments, sensors 621 can include one or more biopotential-signal sensors (e.g., EMG sensors 665, which may be disposed on an interior, user-facing portion of watch body 620 and/or wearable band 610). In some embodiments, sensors 621 may include one or more capacitive sensors 666. In some embodiments, sensors 621 may include one or more heart rate sensors 667. In some embodiments, sensors 621 may include one or more IMU sensors 668. In some embodiments, one or more IMU sensors 668 can be configured to detect movement of a user's hand or other location where watch body 520 is placed or held.

In some embodiments, one or more of sensors 621 may provide an example human-machine interface. For example, a set of neuromuscular sensors, such as EMG sensors 665, may be arranged circumferentially around wearable band 610 with an interior surface of EMG sensors 665 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 610 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 679. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 665 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, Sono-myography (SMG) sensors, and electrical impedance tomography (EIT) sensors.

In some embodiments, peripherals interface 661 includes a near-field communication (NFC) component 669, a global-position system (GPS) component 670, a long-term evolution (LTE) component 671, and/or a Wi-Fi and/or Bluetooth communication component 672. In some embodiments, peripherals interface 661 includes one or more buttons 673 (e.g., peripheral buttons 523 and 527 in FIG. 5), which, when selected by a user, cause operations to be performed at watch body 620. In some embodiments, the peripherals interface 661 includes one or more indicators, such as a light emitting diode (LED), to provide a user with visual indicators (e.g., message received, low battery, active microphone and/or camera, etc.).

Watch body 620 can include at least one display 505 for displaying visual representations of information or data to a user, including user-interface elements and/or three-dimensional virtual objects. The display can also include a touch screen for inputting user inputs, such as touch gestures, swipe gestures, and the like. Watch body 620 can include at least one speaker 674 and at least one microphone 675 for providing audio signals to the user and receiving audio input from the user. The user can provide user inputs through microphone 675 and can also receive audio output from speaker 674 as part of a haptic event provided by haptic controller 678. Watch body 620 can include at least one camera 625, including a front camera 625a and a rear camera 625b. Cameras 625 can include ultra-wide-angle cameras, wide angle cameras, fish-eye cameras, spherical cameras, telephoto cameras, depth-sensing cameras, or other types of cameras.

Watch body computing system 660 can include one or more haptic controllers 678 and associated componentry (e.g., haptic devices 676) for providing haptic events at watch body 620 (e.g., a vibrating sensation or audio output in response to an event at the watch body 620). Haptic controllers 678 can communicate with one or more haptic devices 676, such as electroacoustic devices, including a speaker of the one or more speakers 674 and/or other audio components and/or electromechanical devices that convert energy into linear motion such as a motor, a solenoid, electroactive polymer, piezoelectric actuator, electrostatic actuator, or other tactile output generating components (e.g., a component that converts electrical signals into tactile outputs on the device). Haptic controller 678 can provide haptic events that are capable of being sensed by a user of watch body 620. In some embodiments, one or more haptic controllers 678 can receive input signals from an application of applications 682.

In some embodiments, wearable band computing system 630 and/or watch body computing system 660 can include memory 680, which can be controlled by one or more memory controllers of controllers 677. In some embodiments, software components stored in memory 680 include one or more applications 682 configured to perform operations at the watch body 620. In some embodiments, one or more applications 682 may include games, word processors, messaging applications, calling applications, web browsers, social media applications, media streaming applications, financial applications, calendars, docks, etc. In some embodiments, software components stored in memory 680 include one or more communication interface modules 683 as defined above. In some embodiments, software components stored in memory 680 include one or more graphics modules 684 for rendering, encoding, and/or decoding audio and/or visual data and one or more data management modules 685 for collecting, organizing, and/or providing access to data 687 stored in memory 680. In some embodiments, one or more applications 682 and/or one or more modules can work in conjunction with one another to perform various tasks at the watch body 620.

In some embodiments, software components stored in memory 680 can include one or more operating systems 681 (e.g., a Linux-based operating system, an Android operating system, etc.). Memory 680 can also include data 687. Data 687 can include profile data 688A, sensor data 689A, media content data 690, and application data 691.

It should be appreciated that watch body computing system 660 is an example of a computing system within watch body 620, and that watch body 620 can have more or fewer components than shown in watch body computing system 660, can combine two or more components, and/or can have a different configuration and/or arrangement of the components. The various components shown in watch body computing system 660 are implemented in hardware, software, firmware, or a combination thereof, including one or more signal processing and/or application-specific integrated circuits.

Turning to the wearable band computing system 630, one or more components that can be included in wearable band 610 are shown. Wearable band computing system 630 can include more or fewer components than shown in watch body computing system 660, can combine two or more components, and/or can have a different configuration and/or arrangement of some or all of the components. In some embodiments, all, or a substantial portion, of the components of wearable band computing system 630 are included in a single integrated circuit. Alternatively, in some embodiments, components of wearable band computing system 630 are included in a plurality of integrated circuits that are communicatively coupled. As described above, in some embodiments, wearable band computing system 630 is configured to couple (e.g., via a wired or wireless connection) with watch body computing system 660, which allows the computing systems to share components, distribute tasks, and/or perform other operations described herein (individually or as a single device).

Wearable band computing system 630, similar to watch body computing system 660, can include one or more processors 649, one or more controllers 647 (including one or more haptics controllers 648), a peripherals interface 631 that can include one or more sensors 613 and other peripheral devices, a power source (e.g., a power system 656), and memory (e.g., a memory 650) that includes an operating system (e.g., an operating system 651), data (e.g., data 654 including profile data 688B, sensor data 689B, etc.), and one or more modules (e.g., a communications interface module 652, a data management module 653, etc.).

One or more sensors 613 can be analogous to sensors 621 of watch body computing system 660. For example, sensors 613 can include one or more coupling sensors 632, one or more SpO2 sensors 634, one or more EMG sensors 635, one or more capacitive sensors 636, one or more heart rate sensors 637, and one or more IMU sensors 638.

Peripherals interface 631 can also include other components analogous to those included in peripherals interface 661 of watch body computing system 660, including an NFC component 639, a GPS component 640, an LTE component 641, a Wi-Fi and/or Bluetooth communication component 642, and/or one or more haptic devices 646 as described above in reference to peripherals interface 661. In some embodiments, peripherals interface 631 includes one or more buttons 643, a display 633, a speaker 644, a microphone 645, and a camera 655. In some embodiments, peripherals interface 631 includes one or more indicators, such as an LED.

It should be appreciated that wearable band computing system 630 is an example of a computing system within wearable band 610, and that wearable band 610 can have more or fewer components than shown in wearable band computing system 630, combine two or more components, and/or have a different configuration and/or arrangement of the components. The various components shown in wearable band computing system 630 can be implemented in one or more of a combination of hardware, software, or firmware, including one or more signal processing and/or application-specific integrated circuits.

Wrist-wearable device 500 with respect to FIG. 5 is an example of wearable band 510 and watch body 520 coupled together, so wrist-wearable device 500 will be understood to include the components shown and described for wearable band computing system 630 and watch body computing system 660. In some embodiments, wrist-wearable device 500 has a split architecture (e.g., a split mechanical architecture, a split electrical architecture, etc.) between watch body 520 and wearable band 510. In other words, all of the components shown in wearable band computing system 630 and watch body computing system 660 can be housed or otherwise disposed in a combined wrist-wearable device 500 or within individual components of watch body 520, wearable band 510, and/or portions thereof (e.g., a coupling mechanism 516 of wearable band 510). The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 500 can be used in conjunction with a head-wearable device (e.g., AR system 700 and VR system 800) and/or an HIPD, and wrist-wearable device 500 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR system 700 and VR headset 800.

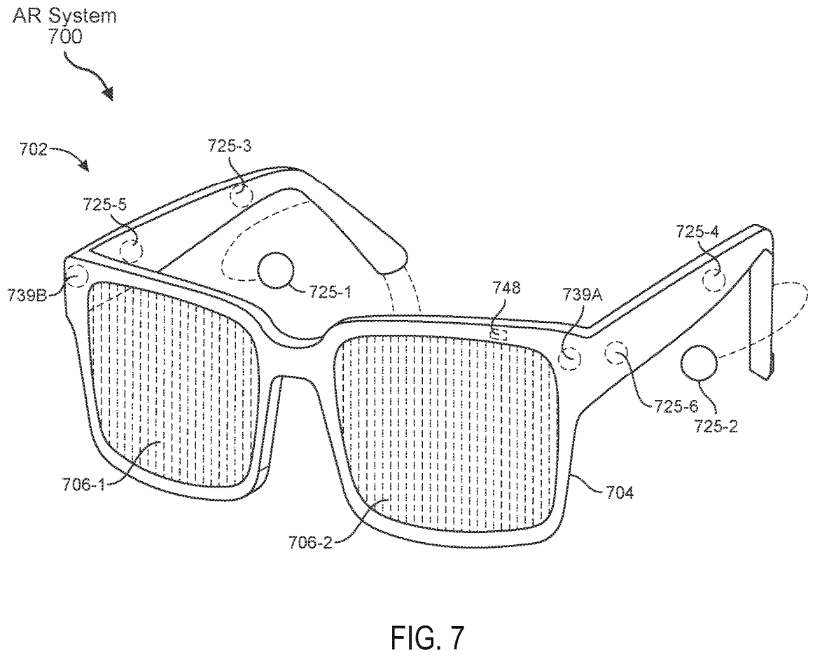

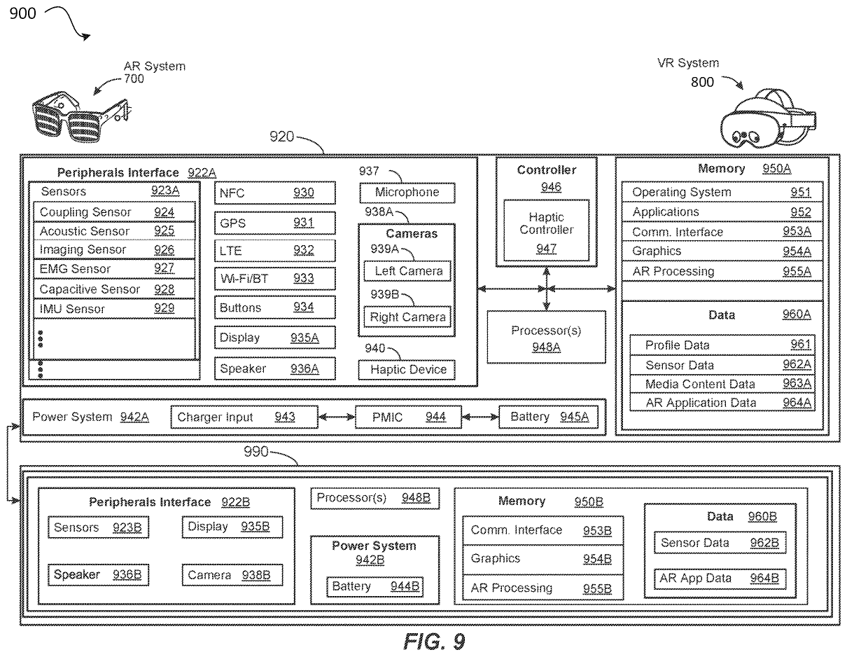

FIG. 7 is a schematic diagram illustrating an example of an AR system using some aspects of the subject technology. FIG. 7 show an example visual depiction of AR system 700, including an eyewear device 702 (which may also be described herein as augmented-reality glasses, and/or smart glasses). AR system 700 can include additional electronic components that are not shown in FIG. 7, such as a wearable accessory device and/or an intermediary processing device, in electronic communication or otherwise configured to be used in conjunction with the eyewear device 702. In some embodiments, the wearable accessory device and/or the intermediary processing device may be configured to couple with eyewear device 702 via a coupling mechanism in electronic communication with a coupling sensor 924 (FIG. 9), where coupling sensor 924 can detect when an electronic device becomes physically or electronically coupled with eyewear device 702. In some embodiments, eyewear device 702 can be configured to be coupled to a housing 990 (FIG. 9), which may include one or more additional coupling mechanisms configured to couple with additional accessory devices. The components shown in FIG. 7 can be implemented in hardware, software, firmware, or a combination thereof, including one or more signal-processing components and/or application-specific integrated circuits (ASICs).

Eyewear device 702 includes mechanical glasses components, including a frame 704 configured to hold one or more lenses (e.g., one or both of lenses 706-1 and 706-2). One of ordinary skill in the art will appreciate that eyewear device 702 can include additional mechanical components, such as hinges configured to allow portions of frame 704 of eyewear device 702 to be folded and unfolded, a bridge configured to span the gap between lenses 706-1 and 706-2 and rest on the user's nose, nose pads configured to rest on the bridge of the nose and provide support for eyewear device 702, earpieces configured to rest on the user's ears and provide additional support for eyewear device 702, temple arms configured to extend from the hinges to the earpieces of eyewear device 702, and the like. One of ordinary skill in the art will further appreciate that some examples of AR system 700 can include none of the mechanical components described herein. For example, smart contact lenses configured to present artificial reality to users may not include any components of eyewear device 702.

Eyewear device 702 includes electronic components, many of which will be described in more detail below with respect to FIG. 7. Some example electronic components are illustrated in FIG. 7, including acoustic sensors 725-1, 725-2, 725-3, 725-4, 725-5, and 725-6, which can be distributed along a substantial portion of the frame 704 of eyewear device 702. Eyewear device 702 also includes a left camera 739A and a right camera 739B, which are located on different sides of the frame 704. Eyewear device 702 also includes a processor 748 (or any other suitable type or form of integrated circuit) that is embedded into a portion of frame 704.

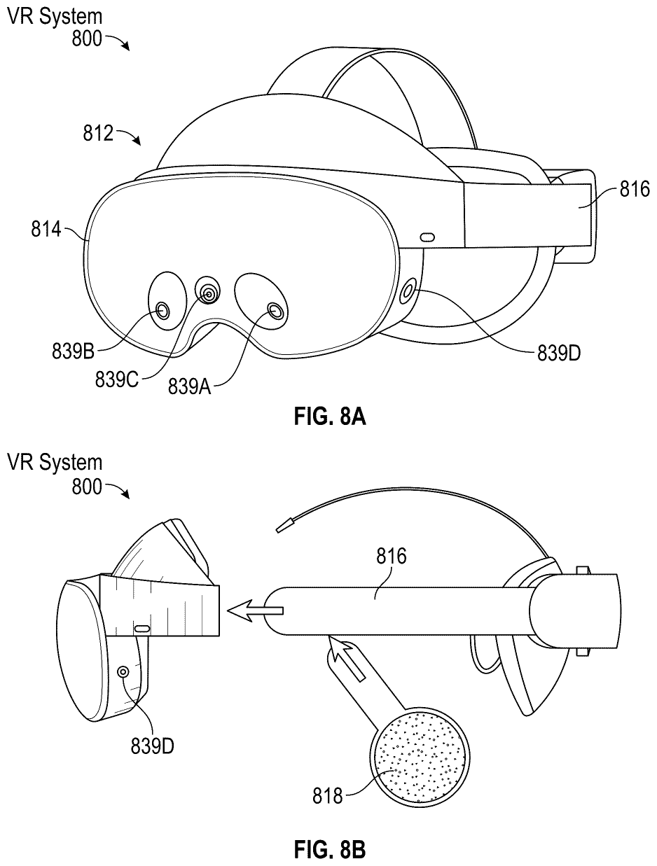

FIGS. 8A and 8B are schematic diagrams illustrating different views of an example virtual reality (VR) system using some aspects of the subject technology. FIGS. 8A and 8B show a VR system 800 that includes a head-mounted display (HMD) 812 (e.g., also referred to herein as an artificial-reality headset, a head-wearable device, a VR headset, etc.), in accordance with some embodiments. As noted, some artificial-reality systems (e.g., AR system 700) may, instead of blending an artificial reality with actual reality, substantially replace one or more of a user's visual and/or other sensory perceptions of the real world with a virtual experience (e.g., AR systems 300 and 400). HMD 812 includes a front body 814 and a frame 816 (e.g., a strap or band) shaped to fit around a user's head.

In some embodiments, front body 814 and/or frame 816 includes one or more electronic elements for facilitating presentation of and/or interactions with an AR and/or VR system (e.g., displays, IMUs, tracking emitter or detectors). In some embodiments, HMD 812 includes output audio transducers (e.g., an audio transducer 818), as shown in FIG. 8B. In some embodiments, one or more components, such as the output audio transducer(s) 818 and frame 816, can be configured to attach and detach (e.g., are detachably attachable) to HMD 812 (e.g., a portion or all of frame 816, and/or audio transducer 818), as shown in FIG. 8B. In some embodiments, coupling a detachable component to HMD 812 causes the detachable component to come into electronic communication with HMD 812.

FIGS. 8A and 8B also show that VR system 800 includes one or more cameras, such as left camera 839A and right camera 839B, which can be analogous to left and right cameras 739A and 739B on frame 704 of eyewear device 702. In some embodiments, VR system 800 includes one or more additional cameras (e.g., cameras 839C and 839D), which can be configured to augment image data obtained by left and right cameras 839A and 839B by providing more information. For example, camera 839C can be used to supply color information that is not discerned by cameras 839A and 839B. In some embodiments, one or more cameras 839A to 839D can include an optional IR cut filter configured to remove IR light from being received at the respective camera sensors.

FIG. 9 is a schematic diagram 900 illustrating an example architecture of an AR and VR system using some aspects of the subject technology. FIG. 9 illustrates a computing system 920 and an optional housing 990, each of which show components that can be included in AR system 700 and/or VR system 800. In some embodiments, more or fewer components can be included in optional housing 990 depending on practical restraints of the respective AR system being described.

In some embodiments, computing system 920 can include one or more peripherals interfaces 922A and/or optional housing 990 can include one or more peripherals interfaces 922B. Each of computing system 920 and optional housing 990 can also include one or more power systems 942A and 942B, one or more controllers 946 (including one or more haptic controllers 947), one or more processors 948A and 948B (as defined above, including any of the examples provided), and memory 950A and 950B, which can all be in electronic communication with each other. For example, the one or more processors 948A and 948B can be configured to execute instructions stored in memory 950A and 950B, which can cause a controller of one or more of controllers 946 to cause operations to be performed at one or more peripheral devices connected to peripherals interfaces 922A and/or 922B. In some embodiments, each operation described can be powered by electrical power provided by power system 942A and/or 942B.

In some embodiments, peripherals interface 922A can include one or more devices configured to be part of computing system 920, some of which have been defined above and/or described with respect to the wrist-wearable devices shown in FIGS. 5 and 6. For example, peripherals interface 922A can include one or more sensors 923A. Some example sensors 923A include one or more coupling sensors 924, one or more acoustic sensors 925, one or more imaging sensors 926, one or more EMG sensors 927, one or more capacitive sensors 928, one or more IMU sensors 929, and/or any other types of sensors explained above or described with respect to any other embodiments discussed herein.

In some embodiments, peripherals interfaces 922A and 922B can include one or more additional peripheral devices, including one or more NFC devices 930, one or more GPS devices 931, one or more LTE devices 932, one or more Wi-Fi and/or Bluetooth devices 933, one or more buttons 934 (e.g., including buttons that are slidable or otherwise adjustable), one or more displays 935A and 935B, one or more speakers 936A and 936B, one or more microphones 937, one or more cameras 938A and 938B (e.g., including the left camera 939A and/or a right camera 939B), one or more haptic devices 940, and/or any other types of peripheral devices defined above or described with respect to any other embodiments discussed herein.

AR systems can include a variety of types of visual feedback mechanisms (e.g., presentation devices). For example, display devices in AR system 700 and/or VR system 800 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 935A and 935B can be coupled to each of the lenses 706-1 and 706-2 of AR system 700. Displays 935A and 935B may be coupled to each of lenses 706-1 and 706-2, which can act together or independently to present an image or series of images to a user. In some embodiments, AR system 700 includes a single display 935A or 935B (e.g., a near-eye display) or more than two displays 935A and 935B. In some embodiments, a first set of one or more displays 935A and 935B can be used to present an augmented-reality environment, and a second set of one or more display devices 935A and 935B can be used to present a virtual-reality environment. In some embodiments, one or more waveguides are used in conjunction with presenting artificial-reality content to the user of AR system 700 (e.g., as a means of delivering light from one or more displays 935A and 935B to the user's eyes). In some embodiments, one or more waveguides are fully or partially integrated into the eyewear device 702. Additionally, or alternatively to display screens, some artificial-reality systems include one or more projection systems. For example, display devices in AR system 700 and/or VR system 800 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 935A and 935B.

Computing system 920 and/or optional housing 990 of AR system 700 or VR system 800 can include some or all of the components of a power system 942A and 942B. Power systems 942A and 942B can include one or more charger inputs 943, one or more PMICs 944, and/or one or more batteries 945A and 944B.

Memory 950A and 950B may include instructions and data, some or all of which may be stored as non-transitory computer-readable storage media within the memories 950A and 950B. For example, memory 950A and 950B can include one or more operating systems 951, one or more applications 952, one or more communication interface applications 953A and 953B, one or more graphics applications 954A and 954B, one or more AR processing applications 955A and 955B, and/or any other types of data defined above or described with respect to any other embodiments discussed herein.

Memory 950A and 950B also include data 960A and 960B, which can be used in conjunction with one or more of the applications discussed above. Data 960A and 960B can include profile data 961, sensor data 962A and 962B, media content data 963A, AR application data 964A and 964B, and/or any other types of data defined above or described with respect to any other embodiments discussed herein.

In some embodiments, controller 946 of eyewear device 702 may process information generated by sensors 923A and/or 923B on eyewear device 702 and/or another electronic device within AR system 700. For example, controller 946 can process information from acoustic sensors 725-1 and 725-2. For each detected sound, controller 946 can perform a direction of arrival (DOA) estimation to estimate a direction from which the detected sound arrived at eyewear device 702 of AR system 700. As one or more of acoustic sensors 925 (e.g., the acoustic sensors 725-1, 725-2) detects sounds, controller 946 can populate an audio data set with the information (e.g., represented in FIG. 9 as sensor data 962A and 962B).

In some embodiments, a physical electronic connector can convey information between eyewear device 702 and another electronic device and/or between one or more processors 748, 948A, 948B of AR system 700 or VR system 800 and controller 946. The information can be in the form of optical data, electrical data, wireless data, or any other transmittable data form. Moving the processing of information generated by eyewear device 702 to an intermediary processing device can reduce weight and heat in the eyewear device, making it more comfortable and safer for a user. In some embodiments, an optional wearable accessory device (e.g., an electronic neckband) is coupled to eyewear device 702 via one or more connectors. The connectors can be wired or wireless connectors and can include electrical and/or non-electrical (e.g., structural) components. In some embodiments, eyewear device 702 and the wearable accessory device can operate independently without any wired or wireless connection between them.

In some situations, pairing external devices, such as an intermediary processing device (e.g., HIPD 306, 406) with eyewear device 702 (e.g., as part of AR system 700) enables eyewear device 702 to achieve a similar form factor of a pair of glasses while still providing sufficient battery and computation power for expanded capabilities. Some, or all, of the battery power, computational resources, and/or additional features of AR system 700 can be provided by a paired device or shared between a paired device and eyewear device 702, thus reducing the weight, heat profile, and form factor of eyewear device 702 overall while allowing eyewear device 702 to retain its desired functionality. For example, the wearable accessory device can allow components that would otherwise be included on eyewear device 702 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 702 standing alone. Because weight carried in the wearable accessory device can be less invasive to a user than weight carried in the eyewear device 702, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 700 and/or VR system 800 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 8A and 8B show VR system 800 having cameras 839A to 839D, which can be used to provide depth information for creating a voxel field and a two-dimensional mesh to provide object information to the user to avoid collisions.

In some embodiments, AR system 700 and/or VR system 800 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial reality devices, within other artificial reality devices, and/or in conjunction with other artificial reality devices.

In some embodiments of an artificial reality system, such as AR system 700 and/or VR system 800, ambient light (e.g., a live feed of the surrounding environment that a user would normally see) can be passed through a display element of a respective head-wearable device presenting aspects of the AR system. In some embodiments, ambient light can be passed through a portion that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

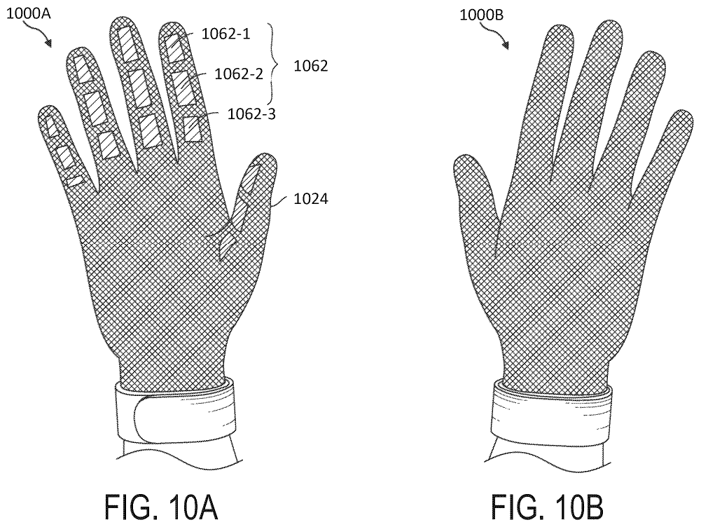

FIGS. 10A and 10B are schematic diagrams illustrating different views of an example haptic feedback device using some aspects of the subject technology. FIGS. 10A and 10B illustrate an example handheld intermediary processing device (HIPD) 1000A-B in accordance with some embodiments. HIPD 1000A is an instance of the intermediary device described herein, such that HIPD 1000A should be understood to have the features described with respect to any intermediary device defined above or otherwise described herein and vice versa. FIG. 10A shows a top view HIPD 1000A and FIG. 10B shows a side view 1000B of the HIPD 1000A. HIPD 1000A is configured to communicatively couple with one or more wearable devices (or other electronic devices) associated with a user. For example, HIPD 1000A is configured to communicatively couple with a user's wrist-wearable device 302, 402 (or components thereof, such as watch body 520 and wearable band 510), AR system 700, and/or VR headset 800. HIPD 1000A can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 1000A can successfully be communicatively coupled with an electronic device, such as a wearable device).

HIPD 1000A can perform various functions independently and/or in conjunction with one or more wearable devices (e.g., wrist-wearable device 302, 402, AR system 700, VR system 800, etc.). HIPD 1000A can be configured to increase and/or improve the functionality of communicatively coupled devices, such as the wearable devices. HIPD 1000A can be configured to perform one or more functions or operations associated with interacting with user interfaces and applications of communicatively coupled devices, interacting with an AR environment, interacting with a VR environment, and/or operating as a human-machine interface controller, as well as functions and/or operations described above with reference to FIGS. 1-9. Additionally, as will be described in more detail below, functionality and/or operations of HIPD 1000A can include, without limitation, task offloading and/or handoffs; thermals offloading and/or handoffs; six degrees of freedom (6DoF) ray-casting and/or gaming (e.g., using imaging devices or cameras, which can be used for simultaneous localization and mapping (SLAM) and/or with other image processing techniques), portable charging, messaging, image capturing via one or more imaging devices or cameras, sensing user input (e.g., sensing a touch on a touch input surface), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 1000A and/or in communication between HIPD 1000A and another wearable device described herein. In some embodiments, functions can be executed on HIPD 1000A in conjunction with an AR environment. As the skilled artisan will appreciate upon reading the descriptions provided herein, HIPD 1000A can be used with any type of suitable AR environment.

While HIPD 1000A is communicatively coupled with a wearable device and/or other electronic device, HIPD 1000A is configured to perform one or more operations initiated at the wearable device and/or the other electronic device. In particular, one or more operations of the wearable device and/or the other electronic device can be offloaded to HIPD 1000A to be performed. HIPD 1000A performs the one or more operations of the wearable device and/or the other electronic device and provides data corresponding to the completed operations to the wearable device and/or the other electronic device. For example, a user can initiate a video stream using AR system 700 and back-end tasks associated with performing the video stream (e.g., video rendering) can be offloaded to HIPD 1000A, which HIPD 1000A performs and provides corresponding data to AR system 700 to perform remaining front-end tasks associated with the video stream (e.g., presenting the rendered video data via a display of AR system 700). In this way, HIPD 1000A, which has more computational resources and greater thermal headroom than a wearable device, can perform computationally intensive tasks for the wearable device, thereby improving performance of an operation performed by the wearable device.

HIPD 1000A includes a multi-touch input surface 1002 on a first side (e.g., a front surface) that is configured to detect one or more user inputs. In particular, multi-touch input surface 1002 can detect single tap inputs, multi-tap inputs, swipe gestures and/or inputs, force-based and/or pressure-based touch inputs, held taps, and the like. Multi-touch input surface 1002 is configured to detect capacitive touch inputs and/or force (and/or pressure) touch inputs. Multi-touch input surface 1002 includes a first touch-input surface 1004 defined by a surface depression and a second touch-input surface 1006 defined by a substantially planar portion. First touch-input surface 1004 can be disposed adjacent to second touch-input surface 1006. In some embodiments, first touch-input surface 1004 and second touch-input surface 1006 can be different dimensions and/or shapes. For example, first touch-input surface 1004 can be substantially circular and second touch-input surface 1006 can be substantially rectangular. In some embodiments, the surface depression of multi-touch input surface 1002 is configured to guide user handling of HIPD 1000. In particular, the surface depression can be configured such that the user holds HIPD 1000A upright when held in a single hand (e.g., such that using imaging devices or cameras 1014A and 1014B are pointed toward a ceiling or the sky). Additionally, the surface depression is configured such that the user's thumb rests within first touch-input surface 1004.

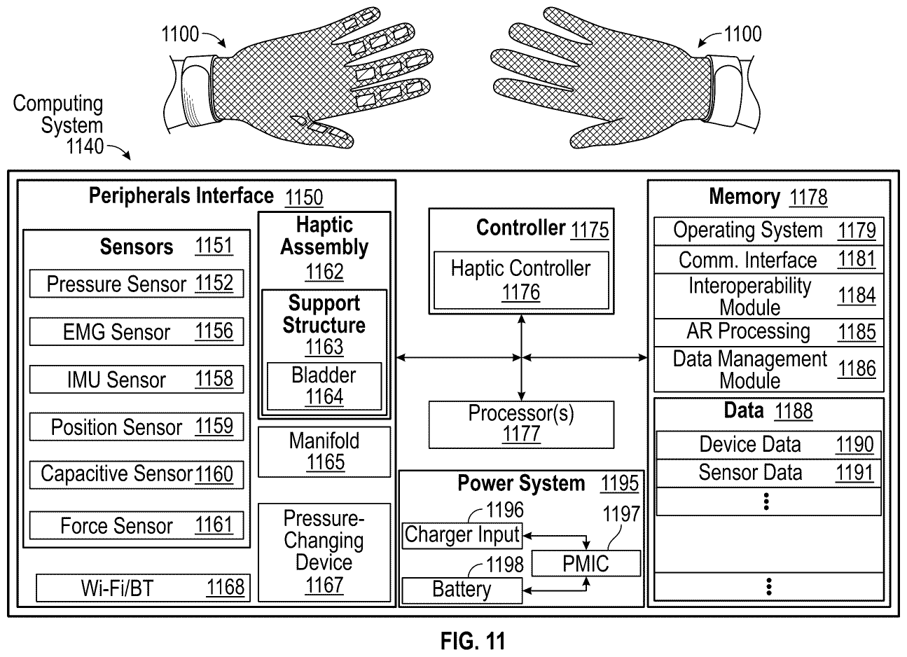

In some embodiments, the different touch-input surfaces include a plurality of touch-input zones. For example, second touch-input surface 1006 includes at least a second touch-input zone 1008 within a first touch-input zone 1007 and a third touch-input zone 1010 within second touch-input zone 1008. In some embodiments, one or more touch-input zones 1008 and 1010 are optional and/or user defined (e.g., a user can specify a touch-input zone based on their preferences). In some embodiments, each touch-input surface 1004 and 1006 and/or touch-input zone 1008 and 1010 are associated with a predetermined set of commands. For example, a user input detected within first touch-input zone 1008 may cause HIPD 1000A to perform a first command and a user input detected within second touch-input surface 1006 may cause HIPD 1000A to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 1008 can be configured to detect force touch inputs (e.g., a magnitude at which the user presses down) and capacitive touch inputs, and second touch-input zone 1010 can be configured to detect capacitive touch inputs. As shown in FIG. 11, HIPD 1000A includes one or more sensors 1151 for sensing data used in the performance of one or more operations and/or functions. For example, HIPD 1000A can include an IMU sensor that is used in conjunction with cameras 1014A, 1014B (FIGS. 10A-10B) for three-dimensional object manipulation (e.g., enlarging, moving, destroying, etc., an object) in an AR or VR environment. Non-limiting examples of sensors 1151 included in HIPD 1000A include a light sensor, a magnetometer, a depth sensor, a pressure sensor, and a force sensor. HIPD 1000A can include one or more light indicators 1012 to provide one or more notifications to the user. In some embodiments, light indicators 1012 are LEDs or other types of illumination devices. Light indicators 1012 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 1004. Light indicators 1012 can be illuminated in different colors and/or patterns to provide the user with one or more notifications and/or information about the device. For example, a light indicator positioned around first touch-input surface 1004 may flash when the user receives a notification (e.g., a message), change red when HIPD 1000A is out of power, operate as a progress bar (e.g., a light ring that is dosed when a task is completed (e.g., 0% to 100%)), operate as a volume indicator, etc.

In some embodiments, HIPD 1000A includes one or more additional sensors on another surface. For example, as shown FIG. 10A, HIPD 1000A includes a set of one or more sensors (e.g., sensor set 1020) on an edge of HIPD 1000. Sensor set 1020, when positioned on an edge of the HIPD 1000, can be pe positioned at a predetermined tilt angle (e.g., 26 degrees), which allows sensor set 1020 to be angled toward the user when placed on a desk or other flat surface. Alternatively, in some embodiments, sensor set 1020 is positioned on a surface opposite the multi-touch input surface 1002 (e.g., a back surface). The one or more sensors of sensor set 1020 are discussed in further detail below.

FIG. 11 is a schematic diagram illustrating an example system architecture of a haptic feedback device using some aspects of the subject technology. In some embodiments, a computing system 1140 of HIPD 1000 can include one or more haptic devices 1171 (e.g., a vibratory haptic actuator) that are configured to provide haptic feedback (e.g., kinesthetic sensation). Sensors 1151 and/or the haptic devices 1171 can be configured to operate in conjunction with multiple applications and/or communicatively coupled devices including, without limitation, wearable devices, health monitoring applications, social media applications, game applications, and artificial reality applications (e.g., the applications associated with artificial reality).

In some embodiments, HIPD 1000 is configured to operate without a display. However, optionally, computing system 1140 of the HIPD 1000A can include a display. HIPD 1000 can also include one or more optional peripheral buttons 1167. For example, peripheral buttons 1167 can be used to turn on or turn off HIPD 1000. Further, HIPD 1000 housing can be formed of polymers and/or elastomers. In other words, HIPD 1000 may be designed such that it would not easily slide off a surface. In some embodiments, HIPD 1000 includes one or more magnets to couple HIPD 1000 to another surface. This allows the user to mount HIPD 1000 to different surfaces and provide the user with greater flexibility in use of HIPD 1000.

As described above, HIPD 1000 can distribute and/or provide instructions for performing the one or more tasks at HIPD 1000 and/or a communicatively coupled device. For example, HIPD 1000 can identify one or more back-end tasks to be performed by HIPD 1000 and one or more front-end tasks to be performed by a communicatively coupled device. While HIPD 1000 is configured to offload and/or hand off tasks of a communicatively coupled device, HIPD 1000 can perform both back-end and front-end tasks (e.g., via one or more processors 1177). HIPD 1000 can, without limitation, be used to perform augmented calling (e.g., receiving and/or sending 3D or 2D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 1000 can perform the above operations alone or in conjunction with a wearable device (or other communicatively coupled electronic device).

FIG. 11 shows a block diagram of a computing system 1140 of HIPD 1000 in accordance with some embodiments. HIPD 1000, described in detail above, can include one or more components shown in HIPD computing system 1140. HIPD 1000 will be understood to include the components shown and described below for HIPD computing system 1140. In some embodiments, all, or a substantial portion of the components of HIPD computing system 1140 are included in a single integrated circuit. Alternatively, in some embodiments, components of HIPD computing system 1140 are included in a plurality of integrated circuits that are communicatively coupled.

HIPD computing system 1140 can include a processor (e.g., a CPU 1177, a GPU, and/or a CPU with integrated graphics), a controller 1175, a peripherals interface 1150 that includes one or more sensors 1151, and other peripheral devices, a power source (e.g., a power system 1195), and memory (e.g., a memory 1178) that includes an operating system (e.g., an operating system 1179), data (e.g., data 1188), one or more applications and one or more modules (e.g., a communications interface module 1181, an interoperability module 1184, an AR processing module 1185, a data management module 1186, etc.). HIPD computing system 1140 further includes a power system 1195 that includes a charger input and output 1196, a PMIC 1197, and a battery 1198, all of which are defined above.

In some embodiments, peripherals interface 1150 can include one or more sensors 1151. Sensors 1151 can include analogous sensors to those described above in reference to FIG. 5. For example, sensors 1151 can include imaging sensors (optional), EMG sensors 1156, IMU sensors 1158, and capacitive sensors 1160. In some embodiments, sensors 1151 can include one or more pressure sensors 1152 for sensing pressure data, an altimeter for sensing an altitude of the HIPD 1000, a magnetometer 1155 for sensing a magnetic field, a depth sensor (or a time-of flight sensor) for determining a difference between the camera and the subject of an image, a position sensor 1159 (e.g., a flexible position sensor) for sensing a relative displacement or position change of a portion of the HIPD 1000, a force sensor 1161 for sensing a force applied to a portion of the HIPD 1000, and a light sensor (e.g., an ambient light sensor) for detecting an amount of lighting. Sensors 1151 can include one or more sensors not shown in FIG. 11.

Analogous to the peripherals described above in reference to FIG. 5, peripherals interface 1150 can also include a support structure 1163, an NFC component, a bladder 1164, an Manifold 1165, a Wi-Fi and/or Bluetooth communication component 1168, a speaker, a haptic device, and a microphone. As noted above, HIPD 1000A can optionally include a display and/or one or more peripheral buttons. Peripherals interface 1150 can further include one or more cameras, touch surfaces, and/or one or more light emitters. Light emitters can be one or more LEDs, lasers, etc, and can be used to project or present information to a user.

Memory 1178 can include high-speed random-access memory and/or nonvolatile memory, such as one or more magnetic disk storage devices, flash memory devices, or other non-volatile solid-state memory devices. Access to memory 1178 by other components of HIPD 1000, such as the one or more processors and peripherals interface 1150, can be controlled by memory controller of controllers 1175.

In some embodiments, software components stored in memory 1178 include one or more operating systems 1179, one or more applications 1180, one or more communication interface modules 1181, one or more graphics modules 1182, and/or one or more data management modules 1186, which are analogous to the software components described above in reference to FIG. 5.

In some embodiments, software components stored in memory 1178 include a task and processing management module for identifying one or more front-end and backend tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module uses data 1188 (e.g., device data 1190) to distribute the one or more front-end and/or back-end tasks based on communicatively coupled devices' computing resources, available power, thermal headroom, ongoing operations, and/or other factors. For example, task and processing management module can cause the performance of one or more back-end tasks (of an operation performed at communicatively coupled AR system 700) at HIPD 1000 in accordance with a determination that the operation is utilizing a predetermined amount (e.g., at least 70%) of computing resources available at AR system 700.

In some embodiments, software components stored in memory 1178 include an interoperability module 1184 for exchanging and utilizing information received and/or provided to distinct communicatively coupled devices. Interoperability module 1184 allows for different systems, devices, and/or applications to connect and communicate in a coordinated way without user input. In some embodiments, software components stored in memory 1178 include an AR processing module 1185 that is configured to process signals based at least on sensor data for use in an AR and/or VR environment. For example, AR processing module 1185 can be used for 3D object manipulation, gesture recognition, facial expression recognition, etc.

Memory 1178 can also include data 1188. In some embodiments, data 1188 can include profile data, device data 1190 (including device data of one or more devices communicatively coupled with HIPD 1000A, such as device type, hardware, software, configurations, etc.), sensor data 1191, media content data, and application data.

It should be appreciated that HIPD computing system 1140 is an example of a computing system within HIPD 1000, and that HIPD 1000 can have more or fewer components than shown in HIPD computing system 1140, combine two or more components, and/or have a different configuration and/or arrangement of the components. The various components shown in HIPD computing system 1140 are implemented in hardware, software, firmware, or a combination thereof, including one or more signal processing and/or application-specific integrated circuits.

The techniques described above in FIGS. 10A, 10B, and 11 can be used with any device used as a human-machine interface controller. In some embodiments, an HIPD 1000 can be used in conjunction with one or more wearable devices such as a head-wearable device (e.g., AR system 700 and VR system 800) and/or a wrist-wearable device 500 (or components thereof).

In some embodiments, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

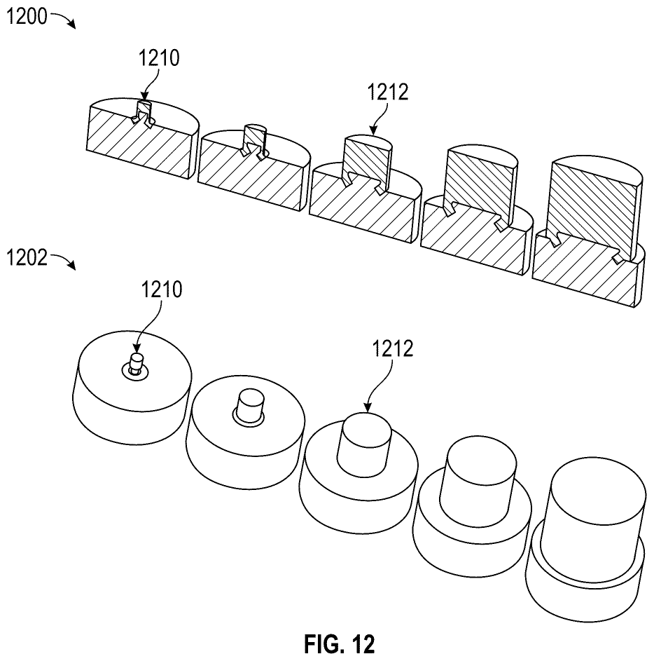

FIG. 12 is a schematic diagram illustrating an example process of over-molding conductive elastomers onto conductive pins, in accordance with some aspects of the subject technology. In FIG. 12, the process of over-molding of conductive (e.g., metallic) pins 1210 by the conductive polymers (e.g., elastomers) 1212 is shown in the cross-sectional views 1200 and the perspective views 1202, which indicate gradual growth of the conductive elastomers 1212. The conductive elastomers 1212 can be over-molded on the metallic pins 1210 through compression molding and/or injection molding. In some embodiments, the conductive contact interface may be formed by dual-shot injection molding of the conductive and non-conductive elastomers to form the detachable interface/interconnect.

Over-molding conductive elastomers onto metallic pins enhances long-term adhesion and reliability through both mechanical and chemical mechanisms. During the over-molding process, the uncured silicone composite conforms specifically to the extruded reverse trapezoid geometry of the metal pin, as shown in FIG. 12, creating a robust mechanical lock. Chemical adhesion is further improved by applying Loctite primer, which promotes bonding between the polymer and metal surfaces. Once crosslinking is complete, this engineered interface ensures stable electrical signal transmission, minimizes interfacial resistance, and maintains reliable connectivity over time.

Long-term adhesion and reliability of over-molded coupons have not been tested. Preliminary test results performed to apply 3-mercaptopropyltrimethoxysilane as self-assembled-monolayer where trimethoxysilane forms silane-silicone bonding and thiol effectively increases surface energy of copper, thus decreasing water contact angle from 68.95° of bare copper to 77.01°. Further experiments can be performed to modify the coating process to further improve adhesion between metallic pins and conductive elastomers.

Precise alignment of conductive and non-conductive regions during molding is essential to maintain consistent contact geometry and prevent electrical shorting. This process can be challenging due to the need for exact placement and separation of materials within the mold. To address this, a dowel pin is used to ensure precise alignment of the mold components, helping maintain the integrity of the interface and reducing the risk of misalignment-related defects.

Consistent contact geometry in over-molded polymer pins depends on precise control over both diameter and height. In testing, four pin diameters—0.5 mm, 1.0 mm, 1.5 mm, and 2.0 mm—were evaluated, with each pin's height set to 75% of its diameter. All metallic pins used as the base have a diameter of about 2.4 mm and a thickness of about 1.0 mm. Attempts to produce pins with about a 0.3 mm diameter resulted in inconsistent samples, highlighting the practical limitations of miniaturization and the importance of maintaining tight tolerances for reliable contact performance.

The disclosed conductive polymer contacts may leverage properties of conductive polymers to mitigate the issues observed with metal interfaces including corrosion resistance, waterproof and ingress protection, compliance and low modulus, and manufacturability and cost.

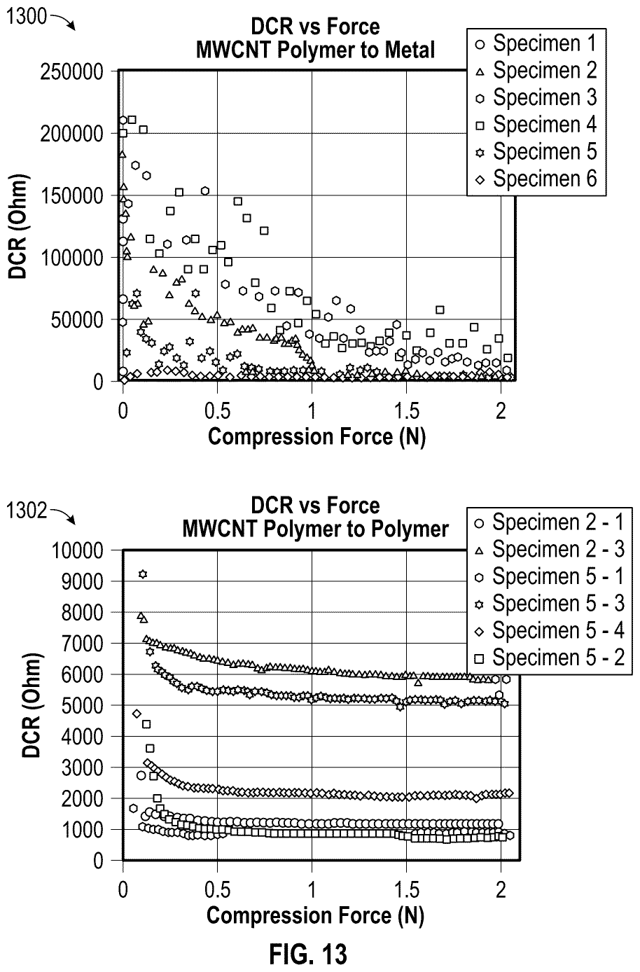

FIG. 13 illustrates charts 1300 and 1302 of mechanical performance of an example conductive polymer interface, in accordance with some aspects of the subject technology. The chart 1300 shows direct contact resistance (DCR) (Ω) versus compression force (N) for a number of specimens produced by compression molding of MWCNT to metal. The chart 1302 shows DCR) (Ω) versus compression force (N) for a number of specimens produced by compression molding of MWCNT to conductive polymer. Measured contact resistance of 1.5 mm diameter pins using 10 wt % MWCNT in silicone is shown in the illustration above. Polymer-polymer interface demonstrates more stable readout compared to polymer-metal interface. On average, at IN compression force, polymer-metal interface has a resistance of about 50 kΩ and polymer-polymer interface has a resistance of about 4 kΩ. The measured contact resistance decreases with increase in force due to higher effective contact area. Contact resistance between polymer-metal is always greater than polymer-polymer due to the combined effects of higher energy barrier from work function mismatch, and higher effective contact area from dual-side surface deformation.

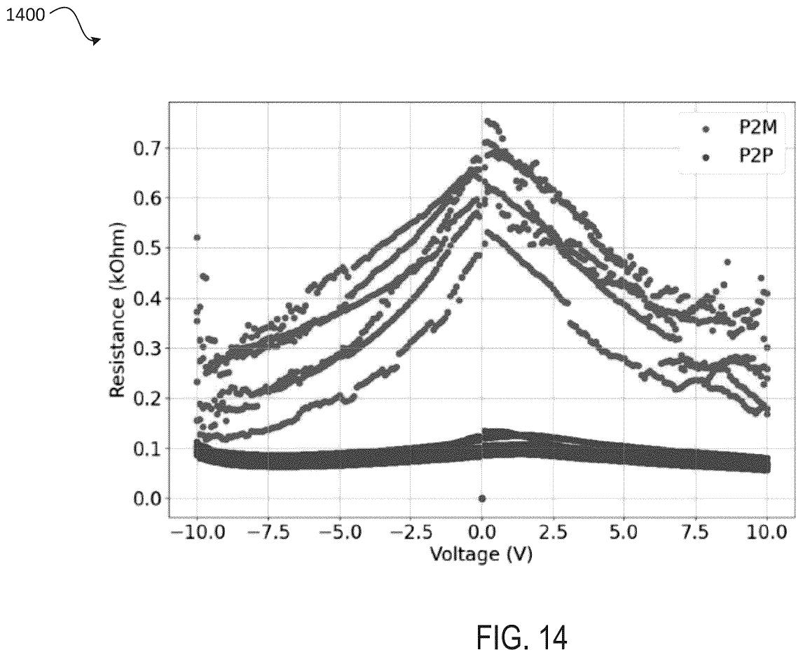

FIG. 14 is a chart 1400 illustrating electrical performance of an example conductive polymer interface, in accordance with some aspects of the subject technology. The over-molded pins were subjected to repeated compression and release cycles up to 3N with no changes in resistance at polymer-polymer and polymer-metal interface. The illustration in chart 1400 shows resistance scans after the compression cycle across the −10V to 10V voltage window for polymer-polymer (P2P) and polymer-metal (P2M) using 5 wt % single-walled carbon nanotube (SWCNT) as a filler.

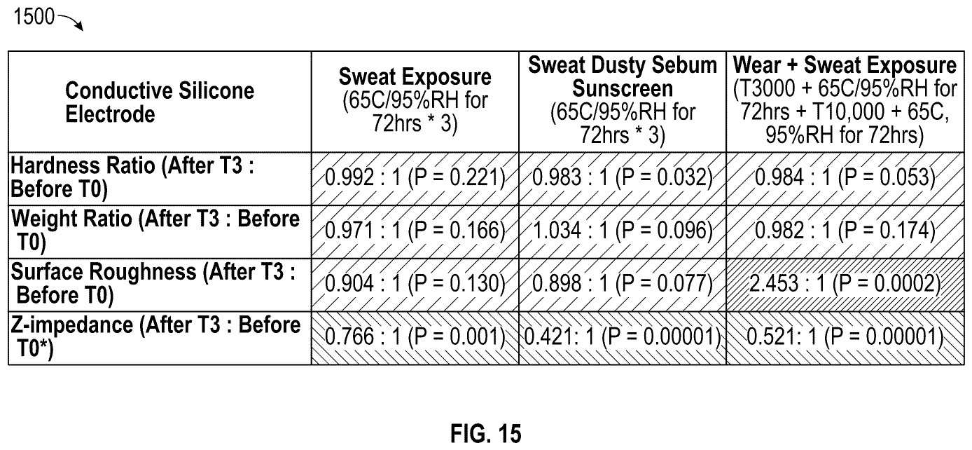

FIG. 15 is a table 1500 illustrating values of various parameters of an example conductive polymer interface due to wear or environmental exposure, in accordance with some aspects of the subject technology. The table shows that after repeated cycles of sweat exposure, sweat dusty sebum sunscreen exposure, and wear and sweat exposure, the conductive silicone electrode becomes softer and the resistance decreases, potentially leading to improved signal strength.

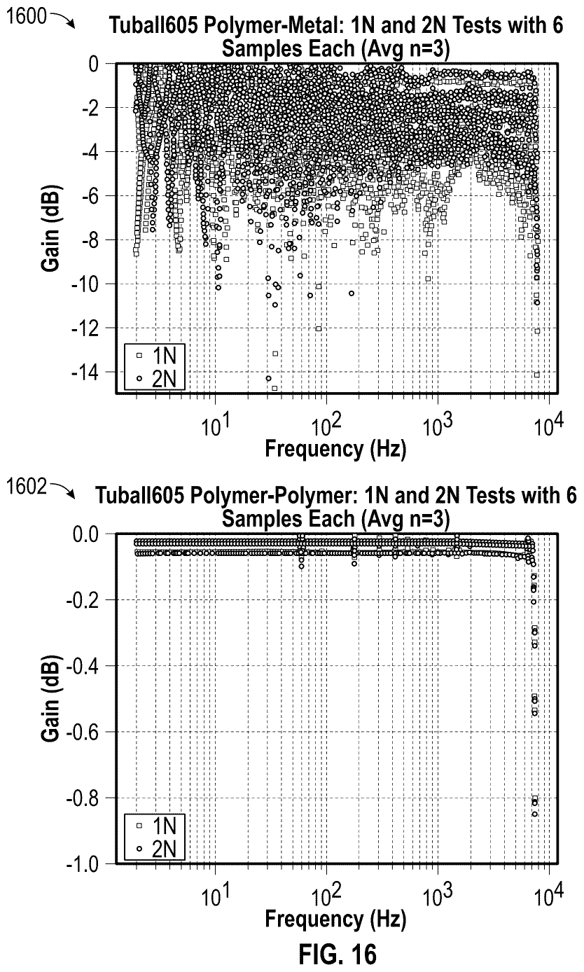

FIG. 16 illustrates charts 1600 and 1602 of signal attenuation versus frequency of an example conductive polymer interface, in accordance with some aspects of the subject technology. Higher compliance (lower Young's Modulus) improves contact pressure distribution and maintains stable signal, reducing the need for springs and improving wear resistance. As shown in charts 1600 and 1602, the polymer-metal interface for SWCNT has higher signal attenuation (dB) compared to polymer-polymer interface, which is attributed to dual side deformation of polymer electrodes leading to higher signal stability.

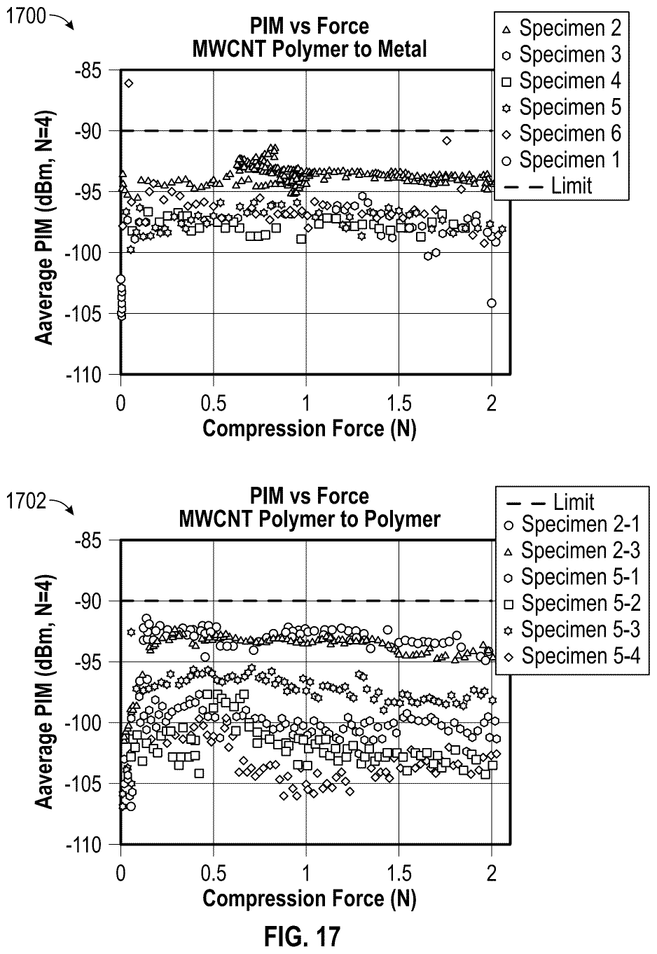

FIG. 17 illustrates charts 1700 and 1702 of PIM versus compressive force of example MWCNT polymer-to-metal and polymer-to-polymer interfaces, in accordance with some aspects of the subject technology. Passive-intermodulation (PIM) shows low risk of coex/nonlinearity with average PIM consistently below −90 dB as shown in charts 1700 and 1702 for MWCNT polymer-to-metal and polymer-to-polymer interfaces.

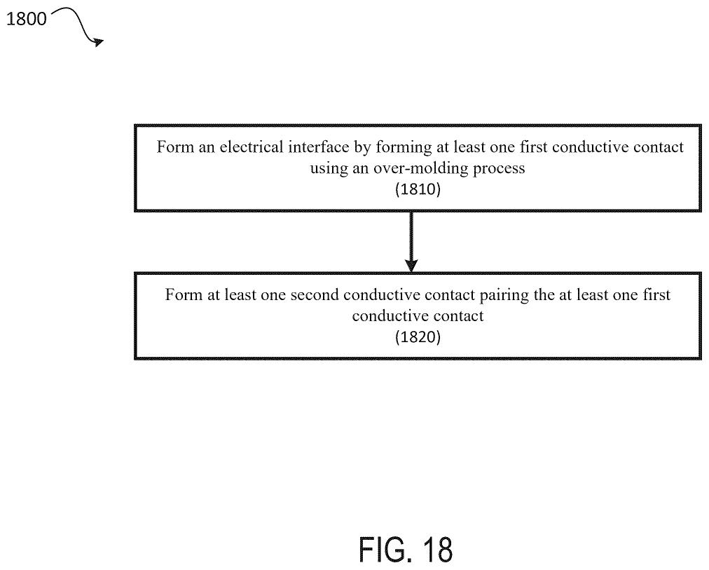

FIG. 18 is a flow diagram illustrating a process 1800 of fabricating a conductive polymer interface, in accordance with some embodiments of the present disclosure. The process 1800 includes process steps 1810 and 1820 described herein.

In process step 1810, an electrical interface is formed by forming at least one first conductive contact using an over-molding process.

In process step 1820, at least one second conductive contact pairing the at least one first conductive contact is formed.

The first conductive contact(s) and the second conductive contact(s) are formed in an underlying nonconductive matrix and are configured to include a conductive polymer.

An aspect of the subject technology is directed to an apparatus comprising an electrical interface including at least one first conductive contact and at least one second conductive contact. The first conductive contact(s) and the second conductive contact(s) are configured to include a conductive polymer and are formed in an underlying nonconductive matrix.

In some implementations, the at least one first conductive contact include a plurality of first contacts and the at least one second conductive contact include a plurality of second contacts.

In one or more implementations, the at least one of the plurality of first contacts or the plurality of second contacts are substantially flat contacts.

In some implementations, the one of the plurality of first contacts or the plurality of second contacts are formed as conductive bumps.

In one or more implementations, the underlying nonconductive matrix is formed of a polymer.

In some implementations, the conductive polymer comprises an elastomer material with a conductive filler.

In one or more implementations, the elastomer material comprises at least one of a thermoset polymer or a thermoplastic polymer.

In some implementations, the thermoset polymer includes at least one of a silicone, a urethane, an acrylate, a methacrylate, a fluoropolymer, an epoxy, a thiol-ene, an unsaturated ester, and a phenolic resin, wherein the thermoplastic polymer comprises a styrenic block copolymer including at least one of a styrene-ethylene/butylene-styrene copolymer (SEBS), a styrene ethylene/proylene-styrene (SEPS) copolymer, a styrene-isoprene-styrene (SIS) block polymer, and a styrene-butadiene-styrene (SBS) block polymer.

In one or more implementations, the method further includes conductive filler comprising at least one of carbon nanotubes or carbon nanofibers including at least one of multi-walled carbon nanotube (MWCNT), single-walled carbon nanotube (SWCNT), silver nano wires and carbon black (CB).

In some implementations, the method further includes at least one first conductive contact or the at least one second conductive contact surrounded by a nonconductive shell.

In one or more implementations, the at least one first conductive contact and the at least one second conductive contact are formed as a coaxial conductive contact pair.

Another aspect of the subject technology is directed to a wearable electronic device comprising an interface to transmit power or signal. The interface includes a number of first conductive contacts and several second conductive contacts. The first conductive contacts and the second conductive contacts are configured to include a conductive polymer and are formed in an underlying nonconductive matrix including a nonconductive polymer.

In some implementations, the plurality of first conductive contacts and the plurality of the second conductive contacts are configured to include a conductive polymer and are formed in an underlying nonconductive matrix including a nonconductive polymer.

In one or more implementations, at least one of the plurality of first conductive contacts or the plurality of second conductive contacts are substantially flat contacts.

In some implementations, at least one of the plurality of first conductive contacts or the plurality of second conductive contacts are formed as conductive bumps.

In one or more implementations, the underlying nonconductive matrix is formed of a polymer, wherein the conductive polymer comprises an elastomer material with a conductive filler.

In some implementations, the elastomer material comprises at least one of a thermoset polymer or a thermoplastic polymer.

In one or more implementations, at least one of the plurality of first conductive contacts or the plurality of second conductive contacts is surrounded by a nonconductive shell, wherein at least one of the plurality of first conductive contacts and the plurality of second conductive contacts are formed as a coaxial conductive contact pair.

Yet another aspect of the subject technology is directed to a method including forming an electrical interface by forming at least one first conductive contact using an over-molding process and forming at least one second conductive contact pairing the first conductive contact(s). The first conductive contact(s) and the second conductive contact(s) are formed in an underlying nonconductive matrix and are configured to include a conductive polymer.

In some implementations, the over-molding process comprises at least one of compression molding or injection molding to form the conductive polymer over a conductive pin, wherein the injection molding includes a dual-shot injection of the conductive polymer.

In one or more implementations, the conductive pin comprises a metallic pin, and the over-molding process includes a precise alignment of conductive and non-conductive regions using dowel pins.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus, comprising:
an electrical interface, including:
at least one first conductive contact; and
at least one second conductive contact,
wherein the at least one first conductive contact and the at least one second conductive contact are configured to include a conductive polymer and are formed in an underlying nonconductive matrix.

2. The apparatus of claim 1, wherein the at least one first conductive contact includes a plurality of first contacts and the at least one second conductive contact includes a plurality of second contacts.

3. The apparatus of claim 2, wherein at least one of the plurality of first contacts or the plurality of second contacts are substantially flat contacts.

4. The apparatus of claim 2, wherein one of the plurality of first contacts or the plurality of second contacts are formed as conductive bumps.

5. The apparatus of claim 1, wherein the underlying nonconductive matrix is formed of a polymer.

6. The apparatus of claim 1, wherein the conductive polymer comprises an elastomer material with a conductive filler.

7. The apparatus of claim 6, wherein the elastomer material comprises at least one of a thermoset polymer or a thermoplastic polymer.

8. The apparatus of claim 7, wherein the thermoset polymer includes at least one of a silicone, a urethane, an acrylate, a methacrylate, a fluoropolymer, an epoxy, a thiol-ene, an unsaturated ester, and a phenolic resin, and wherein the thermoplastic polymer comprises a styrenic block copolymer including at least one of a styrene-ethylene/butylene-styrene copolymer (SEBS), a styrene ethylene/proylene-styrene (SEPS) copolymer, a styrene-isoprene-styrene (SIS) block polymer, and a styrene-butadiene-styrene (SBS) block polymer.

9. The apparatus of claim 7, wherein the conductive filler comprises at least one of carbon nanotubes or carbon nanofibers including at least one of multi-walled carbon nanotube (MWCNT), single-walled carbon nanotube (SWCNT), silver nano wires and carbon black (CB).

10. The apparatus of claim 1, wherein the at least one first conductive contact or the at least one second conductive contact is surrounded by a nonconductive shell.

11. The apparatus of claim 1, wherein the at least one first conductive contact and the at least one second conductive contact are formed as a coaxial conductive contact pair.

12. A wearable electronic device, comprising:
an interface configured to transmit power or signal, the interface comprising:
a plurality of first conductive contacts; and
a plurality of second conductive contacts,
wherein the plurality of first conductive contacts and the plurality of the second conductive contacts are configured to include a conductive polymer and are formed in an underlying nonconductive matrix including a nonconductive polymer.

13. The wearable electronic device of claim 12, wherein at least one of the plurality of first conductive contacts or the plurality of second conductive contacts are substantially flat contacts.

14. The wearable electronic device of claim 12, wherein at least one of the plurality of first conductive contacts or the plurality of second conductive contacts are formed as conductive bumps.

15. The wearable electronic device of claim 12, wherein the underlying nonconductive matrix is formed of a polymer, and wherein the conductive polymer comprises an elastomer material with a conductive filler.

16. The wearable electronic device of claim 15, wherein the elastomer material comprises at least one of a thermoset polymer or a thermoplastic polymer.

17. The wearable electronic device of claim 15, wherein at least one of the plurality of first conductive contacts or the plurality of second conductive contacts is surrounded by a nonconductive shell, and wherein at least one of the plurality of first conductive contacts and the plurality of second conductive contacts are formed as a coaxial conductive contact pair.

18. A method, comprising:
forming an electrical interface by:
forming at least one first conductive contact using an over-molding process; and
forming at least one second conductive contact pairing the at least one first conductive contact,
wherein the at least one first conductive contact and the at least one second conductive contact are formed in an underlying nonconductive matrix and are configured to include a conductive polymer.

19. The method of claim 18, wherein the over-molding process comprises at least one of compression molding or injection molding to form the conductive polymer over a conductive pin, and wherein the injection molding includes a dual-shot injection of the conductive polymer.

20. The method of claim 19, wherein the conductive pin comprises a metallic pin, and wherein the over-molding process includes a precise alignment of conductive and non-conductive regions using dowel pins.
